(19) United States
(12) Patent Application Publication
(10) Pub. No.: US 2012/0263196 A1
(43) Pub. Date: Oct. 18, 2012

(54) ULTRAFAST RAMAN LASER SYSTEMS AND METHODS OF OPERATION

(76) Inventors: Helen Margaret Pask, Seaforth (AU); David James Spence, Forestville (AU); Eduardo Granados, Many Vale (AU); Richard Paul Mildren, Abbotsford (AU)

(21) Appl. No.: 13/515,929

(22) PCT Filed: Dec. 22, 2010
(86) PCT No.: PCT/AU10/01726

§ 371 Date: Jun. 14, 2012

Related U.S. Application Data
(60) Provisional application No. 61/289,303, filed on Dec. 22, 2009.

(51) Int. Cl. H01S 3/30

(52) U.S. Cl. 372/3

(57) ABSTRACT

A Raman laser system, the system comprising a resonator cavity comprising a plurality of reflectors, wherein at least one reflector is an output reflector adapted for outputting a pulsed output beam from the resonator cavity at a frequency corresponding to a Raman shifted frequency of the pump beam, wherein the output reflector is partially transmitting at the Raman-converted frequency; a solid state Raman-active medium located in the resonator cavity to be pumped by a pulsed pump beam having a pump repetition rate and for Raman-converting a pump pulse incident on the Raman-active medium to a resonating pulse at a Raman-converted frequency resonating in the resonator cavity; a resonator adjuster for adjusting the optical length of the resonator to match the round-trip time of the resonating Raman-converted pulse with the pump beam repetition rate such that the resonating pulse is coincident both temporally and spatially with a pump pulse in the Raman-active medium on each round trip, to Raman amplify the resonating pulse at the Raman-converted frequency in the Raman-active medium. Also a multiwavelength Raman laser system further comprising a dispersive element and a plurality of coupled resonator cavities. Also, methods for providing ultrafast pulsed Raman laser operation.

### TECHNICAL FIELD

The present invention relates to ultrafast Raman laser systems and methods for their operation and in particular to mode-locked Raman laser systems and methods of operation and will be described hereinafter with reference to this application. However, it will be appreciated that the invention is not limited to this particular field of use.

### BACKGROUND

Any discussion of the background art throughout the specification should in no way be considered as an admission that such background art is prior art, nor that such background art is widely known or forms part of the common general knowledge in the field.

Ultrafast lasers are common in research laboratories, and the current main types are as follows: Neodymium based lasers (such as Nd:YVO₄ and Nd:YAG) generate picosecond pulses at around 1064 nm, and can be frequency doubled or tripled to 532 nm and 355 nm; Ti:Sapphire lasers can have pulses as short as a few femtoseconds, and operate in the wavelength range 700 to 950 nm (and can be frequency doubled to reach 350-525 nm); fibre lasers based on Yb³⁺ or Er³⁺ dopants operate around 1060 nm and 1500 nm respectively; optically-pumped semiconductor ‘VECSEL’ lasers are a relatively new type of source that can be designed for a individual wavelengths in the visible and infrared; the older technology of dye lasers, while allowing tunable access to visible wavelengths, has all but died out due to the undesirable handling and replacement of carcinogenic dyes.

Outside of the laser laboratory, and particularly in the biophotonics sector, only the two “industry standard” lasers are in mainstream use—the tunable Ti:Sapphire laser and neodymium lasers. These lasers do not provide full spectral coverage, and the yellow to red region between 550 nm and 700 nm is one key area where coverage is poor. While the addition of other lasers and OPO technology in principle could provide full wavelength coverage, in practice this is too cumbersome, complex and costly to be widely available, and so researchers must face the limits imposed by the wavelength restrictions. Therefore, there is considerable interest in the development of picosecond pulse laser sources in the visible region, particularly between 500 and 700 nm.

Two photon fluorescence microscopy is an established biological imaging technique, used widely in conjunction with tunable ultrashort pulse Ti:Sapphire lasers, which typically operate in the range 700-1000 nm. There is however an increasing demand for ultrashort-pulse lasers that can be operated at shorter wavelengths, particularly between 500 and 650 nm, as these would broaden the application of two-photon fluorescence to a much wider range of biological molecules, since this technique would be able use the shorter wavelength radiation for matching the two-photon absorption bands of a wider range of biological samples, either capitalising upon endogenous autofluorescent structures or synthetic fluorophores that serve as the contrast mechanism. Given the nonlinear nature of the excitation, it is desirable that the laser source can generate pulses with high peak power to enhance the non-linear two photon process, while maintaining a low average power to avoid damage to the biological sample under investigation. Perfect wavelength matching to the absorption bands of the fluorophores of interest is not usually required, since they tend to be fairly broad (20-30 nm). Beam quality must also be high to achieve high resolution, and high repetition rates are required for rapid scanning of the sample.

Generating ultrashort pulsed output at 500-700 nm has been addressed in a variety of ways. For instance, optical parametric oscillators (OPOs) have been used to generate tunable ultrafast radiation from the UV to the IR, for example a 1047 nm-pumped OPO with intracavity sum-frequency mixing of the pump and signal has been previously demonstrated to yield tunable femtosecond output in the 608-641 nm range [see for example McConnell et al., Opt. Lett. 28, 1742-1744 (2003)]. However, such systems are typically expensive and complex and require very close control of crystal temperature and angle. Also, the crystals used in OPOs are often hygroscopic and degrade with time (grey-tracking). Furthermore, wavelengths close to the pump wavelength are not accessible, and so a neodymium-pumped OPO must be pumped at 355 nm to generate in the yellow, at the cost of efficiency. These complexities go some way towards explaining the poor take-up of OPOs by non-specialist users. The development of a solid-state laser alternative to tunable visible dye laser technology has been the long-term goal of many laser physicists, and while OPOs have clear potential here, their uptake has been mostly restricted to physics laboratories, largely because of complexity issues.

Another approach is to pump a photonic crystal fiber with the output of a femtosecond Ti:sapphire laser to generate broadband tunable visible radiation in the 500-600 nm range (e.g. Palero et al., Opt. Express 13, 5363-5368 (2005)] with pulses of several picoseconds, but the average power associated with this source was low, allowing only near-threshold two-photon absorption. A third possibility is to employ a femtosecond-pulsed Ti:Sapphire or Nd-based laser for three-photon absorption. However, the peak power requirements for three-photon absorption significantly exceed that for two-photon microscopy and hence this technique has limited applications in biological imaging. There is therefore keen interest and motivation to explore different alternatives that can offer increased simplicity, greater efficiency, and lower cost which provide efficient generation of picosecond pulses at certain desired visible and IR wavelengths, and the generation of short pulses at an extended range of visible wavelengths would be beneficial for several applications in biophotonics including two photon microscopy.

Raman shifting of conventional lasers to access new wavelengths is a well established technique. In particular, stimulated Raman scattering (SRS) in crystalline media has been employed in a wide variety of configurations to efficiently generate IR, visible and UV output. SRS can operate very efficiently using just a single or double pass through a Raman medium for pulses with high peak power. Placing a cavity around the Raman medium to resonate the Stokes wavelength(s) has several significant advantages: it allows conversion of lower-power pulses; it improves beam quality; and it allows effective control over the conversion and cascading of the SRS process to second and higher Stokes orders, so that any desired order can be selectively output, or alternatively multiple wavelengths can be output simultaneously.

For pump pulses with durations of nanoseconds or longer, a short Raman resonator can allow effective SRS conversion of a single pump pulse. For picosecond pulses that are shorter than the transit time through the Raman medium, a simple resonator can no longer be used. Without a resonator, picosecond Stokes generation within one or two passes of the Raman medium can be efficient, the pulse power threshold is much higher than for resonant Raman lasers, the output spectrum is not easily controlled and the output beam is not of sufficient quality to meet the demands of most applications. The solution is to use a resonator pumped by a train of pulses to “synchronously mode lock” an external resonator with a cavity length matched to that of the mode-locked pump laser. Synchronously pumped lasers rely on matching the inter-pulse period of the pump laser with round trip time of the Raman laser resonator to build-up an intense circulating picosecond pulse in the Raman resonator over many pulses. Several groups have reported crystalline and gaseous picosecond Raman oscillators synchronously pumped by finite pulse trains from a Q-switched mode-locked laser enabling the generation of a range of wavelengths in the visible and IR regions. However, all of these schemes employed pulse energies of the order of μJ or even mJ, with the disadvantage of having lower duty cycle and require larger and more complex laser systems. Also, successive pulses within the Q-switched train have different peak power, making them unsuitable for imaging and scanning applications such as scanning microscopy.

It is therefore an object of the present invention to substantially overcome or at least ameliorate one or more of the disadvantages of the prior art, or at least to provide a useful alternative to existing ultrafast laser systems.

### SUMMARY OF THE INVENTION

According to a first aspect, there is provided a synchronously pumped Raman laser system. The system may comprise a resonator cavity comprising a plurality of reflectors. At least one reflector may be an output reflector adapted for outputting a pulsed output beam from the resonator cavity. The pulsed output beam may be at a frequency corresponding to a Raman shifted frequency of the pump beam. The output reflector may be partially transmitting at the Raman-converted frequency. The output reflector may be up to about 80% transmitting in at the Raman-converted frequency. The output reflector may alternatively be up to about 90% transmitting in at the Raman-converted frequency. Greater then about 10% of the Raman-converted frequency may be resonated within the resonator cavity. In some arrangements, the laser system may be a high gain laser system. The gain of the laser system may be greater than 3, greater than 5, or greatest than 10. The gain of the laser system may be between about 1 to 10, about 2 to 10, about 3 to 10, about 4 to 10, or about 5 to 10. In other arrangements, the laser system may be a low gain laser system with gain of between 0.01 (1%) and 1.

The system may further comprise a solid state Raman-active medium located in the resonator cavity to be pumped by a pulsed pump beam. The pulsed pump beam may have a pump repetition rate. The Raman-active medium may Raman-convert a pump pulse incident on the Raman-active medium to a resonating pulse at a Raman-converted frequency. The Raman-converted pulse may resonate in the resonator cavity. The system may further comprise a resonator adjustor for adjusting the optical length of the resonator to match the round-trip time of the resonating Raman-converted pulse with the pump beam repetition rate. The optical length of the resonator may be adjusted such that the resonating pulse is coincident both temporally and spatially with a pump pulse in the Raman-active medium on each round trip, to Raman amplify the resonating pulse at the Raman-converted frequency in the Raman-active medium.

At least one reflector may be an input reflector adapted for admitting the pulsed pump beam to the resonator cavity. Alternatively, the pulsed pump beam may be provided in a non-collinear pumping arrangement.

According to an arrangement of the first aspect, there is provided a synchronously pumped Raman laser system comprising: a resonator cavity comprising a plurality of reflectors, wherein at least one reflector may be an output reflector adapted for outputting a pulsed output beam from the resonator cavity at a frequency corresponding to a Raman shifted frequency of the pump beam, wherein the output reflector may be partially transmitting at the Raman-converted frequency; a solid state Raman-active medium located in the resonator cavity to be pumped by a pulsed pump beam having a pump repetition rate, and for Raman-converting a pump pulse incident on the Raman-active medium to a resonating pulse at a Raman-converted frequency resonating in the resonator cavity; a resonator adjustor for adjusting the optical length of the resonator to match the round-trip time of the resonating Raman-converted pulse with the pump beam repetition rate such that the resonating pulse may be coincident both temporally and spatially with a pump pulse in the Raman-active medium on each round trip, to Raman amplify the resonating pulse at the Raman-converted frequency in the Raman-active medium.

At least one reflector may be an input reflector adapted for admitting the pulsed pump beam to the resonator cavity. Alternatively, the pulsed pump beam may be provided in a non-collinear pumping arrangement.

The resonator adjustor may be configured to translate a selected reflector along an optical axis of the resonator cavity, thereby to adjust the optical length of the resonator cavity. The optical axis of the resonator cavity may be defined to be coincident with a resonating optical mode of the resonator cavity.

The resonator adjustor of any one of the first to the fourth aspects may be configured to adjust the length of the resonator cavity by a length equivalent to a round-trip time difference of +/−33 picoseconds for the Raman converted light in the resonator cavity, corresponding to approximately +/−1 cm in cavity length. The resonator adjustor of any one of the first to the fourth aspects may also be configured for fine adjustments of the length of the resonator cavity on the micrometer-scale (e.g. about 1 to 100 μm) or less (e.g. 500 to 1000 nm).

According to a further arrangement of the first aspect, the system may be adapted for multi-wavelength operation, wherein the resonator cavity is a primary resonator cavity and the pulsed output beam from the primary resonator cavity is a primary frequency-converted beam. The system may further comprise: a secondary resonator cavity comprising a plurality of secondary reflectors, wherein at least one secondary reflector is a secondary output reflector adapted for outputting a secondary pulsed frequency-converted output beam from the secondary resonator cavity at a frequency corresponding to a secondary Raman-converted frequency of the primary output beam, wherein the secondary output reflector is partially transmitting at the secondary Raman-converted frequency; a second solid state Raman-active medium located in the secondary resonator cavity to be pumped by the primary frequency-converted beam and for Raman-converting a pulse of the primary frequency-converted beam incident on the Raman-active medium to a secondary resonating pulse at a secondary Raman-converted frequency resonating in the secondary resonator cavity; a secondary resonator adjustor for adjusting the optical length of the secondary resonator to match the round-trip time of the resonating secondary Raman-converted pulse with the repetition rate of the primary frequency-converted beam such that the secondary resonating pulse is coincident both temporally and spatially with a pulse of the primary frequency-converted beam in the second Raman-active medium on each round trip, to Raman amplify the secondary resonating pulse at the secondary Raman-converted frequency in the second Raman-active medium. At least one secondary reflector may be an input reflector adapted for admitting the primary frequency-converted beam to the secondary resonator cavity. Alternatively, the primary frequency-converted beam to the secondary resonator cavity may be provided in a non-collinear pumping arrangement.

According to a second aspect, the system of the first aspect may be adapted for multiwavelength operation. The multiwavelength system may comprise a dispersive element located in the resonator cavity for spatially dispersing resonating light in the resonator cavity of different wavelengths to create two or a plurality of spatially separated resonating beams in two or more coupled resonator cavities. The system may further comprise two or a plurality of adjustable reflectors corresponding to each of the spatially separated resonating beams. Each of the adjustable reflectors may be located such that a respective spatially separated resonating beam may be incident thereon. Each adjustable reflector may be adapted to adjust the optical length of a respective coupled resonator cavity as seen by its respective spatially separated resonating beam thereby to match the round-trip time of the corresponding spatially separated beam with the pump beam repetition rate or the repetition rate of a beam resonating in the resonator cavity such that each of the spatially separated resonating beams may each be coincident both temporally and spatially in the Raman-active medium on each round trip; thereby to provide a multiwavelength Raman laser system with a pump pulse or pulse of a resonating beam.

According to an arrangement of the second aspect there is provided a Raman laser system according to the first aspect adapted for multiwavelength operation, the system further comprising a dispersive element located in the resonator cavity for spatially dispersing resonating light in the resonator cavity of different wavelengths to create two or a plurality of spatially separated resonating beams in two or more coupled resonator cavities; and two or a plurality of adjustable reflectors corresponding to each of the spatially separated resonating beams, each adjustable reflector located such that a respective spatially separated resonating beam is incident thereon, and wherein each adjustable reflector is adapted to adjust the optical length of a respective coupled resonator cavity as seen by its respective spatially separated resonating beam thereby to match the round-trip time of the corresponding spatially separated beam with the pump beam repetition rate or the repetition rate of abeam resonating in the resonator cavity such that each of the spatially separated resonating beams are each coincident both temporally and spatially in the Raman-active medium on each round trip with a pump pulse or pulse of a resonating beam, thereby to provide a multiwavelength Raman laser system.

According to a third aspect, there is provided a multiwavelength Raman laser system. The system may comprise a resonator cavity comprising a plurality of reflectors. The system may further comprise a solid state Raman-active medium located in the resonator cavity, to be pumped by a pulsed pump beam and for Raman converting light in the resonator cavity incident thereon. The pump beam may have a pump repetition rate. The system may further comprise a dispersive element located in the resonator cavity for spatially dispersing resonating light in the cavity of different wavelengths to create two or a plurality of spatially separated resonating beams in the resonator cavity. The system may further comprise two or a plurality of adjustable reflectors located such that a respective spatially separated resonating beam may be incident thereon to form a plurality of coupled resonator cavities. Each adjustable reflector may be adapted to adjust the optical length of the respective coupled resonator cavity as seen by its respective spatially separated beam thereby to match the round-trip time of the corresponding spatially separated beam with the pump beam repetition rate or the repetition rate of a beam resonating in the resonator cavity such that each of the spatially separated resonating beams are each coincident both temporally and spatially in the Raman-active medium on each round trip with a pump pulse or pulse of a resonating beam. At least one of the adjustable reflectors may be an output reflector adapted for outputting a pulsed output beam from the resonator cavity at a frequency corresponding to a Raman shifted frequency of the pump beam. The output reflector may be partially transmitting at the Raman-shifted frequency. At least one reflector may be an input reflector adapted for admitting the pulsed pump beam to the resonator cavity. Alternatively, the pulsed pump beam may be provided in a non-collinear pumping arrangement.

According to an arrangement of the third aspect, there is provided a multiwavelength Raman laser system comprising a resonator cavity comprising a plurality of reflectors; a solid state Raman-active medium located in the resonator cavity, to be pumped by a pulsed pump beam having a pump repetition rate, and for Raman converting light in the resonator cavity incident thereon; a dispersive element located in the resonator cavity for spatially dispersing resonating light in the cavity of different wavelengths to create two or a plurality of spatially separated resonating beams in the resonator cavity; two or a plurality of adjustable reflectors located such that a respective spatially separated resonating beam may be incident thereon to form two or a plurality of coupled resonator cavities, and wherein each adjustable reflector may be adapted to adjust the optical length of the respective coupled resonator cavity as seen by its respective spatially separated beam thereby to match the round-trip time of the corresponding spatially separated beam with the pump beam repetition rate or the repetition rate of a beam resonating in the resonator cavity such that each of the spatially separated resonating beams are each coincident both temporally and spatially in the Raman-active medium on each round trip with a pump pulse or pulse of a resonating beam, wherein at least one of the adjustable reflectors may be an output reflector adapted for outputting a pulsed output beam from the resonator cavity at a frequency corresponding to a Raman shifted frequency of the pump beam, wherein the output reflector is partially transmitting at the Raman-shifted frequency.

At least one reflector may be an input reflector adapted for admitting the pulsed pump beam to the resonator cavity. Alternatively, the pulsed pump beam may be provided in a non-collinear pumping arrangement.

According to a fourth aspect there is provided a multiwavelength Raman laser system. The system may comprise a plurality of reflectors defining at least two coupled resonator cavities each adapted to resonate a different frequency of light. At least two of the plurality of reflectors may be adjustable reflectors, each adjustable reflector associated with a respective coupled resonator cavity. The system may further comprise a solid state Raman-active medium for Raman converting light in the resonator cavity incident thereon. The Raman-active medium may be located in each of the coupled resonator cavities and adapted to be pumped by a pulsed pump beam having a pump repetition rate. The system may further comprise a dispersive element located in the each of the coupled resonator cavities for spatially dispersing light of different frequencies to form at least two spatially separated beams. Each of the spatially separated beams may be of a frequency adapted to be resonated in a respective coupled resonator cavity. Each of the adjustable reflectors is adapted to independently adjust the optical length of a respective coupled resonator cavity to match the round-trip time of the corresponding spatially separated beam with the pump beam repetition rate or the repetition rate of a beam resonating in the resonator cavity such that pulses of light resonating in each of the coupled resonator cavities are each coincident both temporally and spatially in the Raman-active medium on each round trip with a pump pulse or pulse of a resonating beam. At least one reflector may be an input reflector adapted for admitting the pulsed pump beam to the resonator cavity. Alternatively, the pulsed pump beam may be provided in a non-collinear pumping arrangement.

According to an arrangement of the fourth aspect, there is provided a multiwavelength Raman laser system comprising: a plurality of reflectors defining at least two coupled resonator cavities adapted to resonate a different frequency of light, wherein at least two of the plurality of reflectors are adjustable reflectors, each adjustable reflector associated with a respective coupled resonator cavity; a solid state Raman-active medium for Raman converting light in the resonator cavity incident thereon, the Raman-active medium being located in each of the coupled resonator cavities and adapted to be pumped by a pulsed pump beam having a pump repetition rate; a dispersive element located in the each of the coupled resonator cavities for spatially dispersing light of different frequencies to form at least two spatially separated beams, wherein each of the spatially separated beams may be of a frequency adapted to be resonated in a respective coupled resonator cavity; wherein each of the adjustable reflectors may be adapted to independently adjust the optical length of a respective coupled resonator cavity to match the round-trip time of the corresponding spatially separated beam with the pump beam repetition rate or the repetition rate of a beam resonating in the resonator cavity such that pulses of light resonating in each of the coupled resonator cavities are each coincident both temporally and spatially in the Raman-active medium on each round trip with a pump pulse or pulse of a resonating beam.

At least one reflector may be an input reflector adapted for admitting the pulsed pump beam to the resonator cavity. Alternatively, the pulsed pump beam may be provided in a non-collinear pumping arrangement.

At least one of the adjustable reflectors of any one of the second to the fourth aspects may be adapted to output a portion of light resonating in the respective resonator cavity. Alternatively, a reflector other than one of the adjustable reflectors may be adapted to output a portion of light at one or more selected output frequencies resonating in the resonator cavities.

An example arrangement of system of the second to fourth aspects may comprise three coupled resonator cavities, each cavity adapted to resonate a different frequency of spatially separated light; and three adjustable reflectors each associated with a different resonator cavity to that of each of the other adjustable reflectors and adapted to adjust the optical length of the respective coupled resonator cavity with which it is associated to match the round-trip time of the corresponding spatially separated beam with the pump beam repetition rate or the repetition rate of a beam of different frequency resonating in a different resonator cavity such that each of the spatially separated resonating beams are each coincident both temporally and spatially in the Raman-active medium on each round trip with a pump pulse or pulse of a resonating beam.

An alternative example arrangement of the system of the second to fourth aspects may comprise four or more coupled resonator cavities, each cavity adapted to resonate a different frequency of spatially separated light; and four or more adjustable reflectors each associated with a different resonator cavity and adapted to adjust the optical length of a respective coupled resonator cavity to match the round-trip time of the corresponding spatially separated beam with the pump beam repetition rate or the repetition rate of a beam of different frequency resonating in a different resonator cavity such that each of the spatially separated resonating beams are each coincident both temporally and spatially in the Raman-active medium on each round trip with a pump pulse or pulse of a resonating beam.

The dispersive element of any one of the second to the fourth aspects, may spatially disperse two or more Raman shifted beams in the resonator cavity. The Raman shifted beams may correspond to the first, second, third or higher Stokes orders of the Raman-active medium with respect to the frequency of the pump beam. Each of the adjustable reflectors associated with each respective spatially separated beam may be configured to correspond to the respective Stokes order of the spatially separated resonating beam. The dispersive element may be selected from the group of: a grating; a prism: and a pair of prisms.

The Raman shifted frequency of any one of the first to the fourth aspects may be either a first, second, third or higher Stokes frequency of the pump beam obtained from Raman shifting the pump beam by a characteristic Raman shift of the Raman-active medium. Each of the spatially separated beams of the second to the fourth aspects may be either a first, second, third or higher Stokes frequency of the pump beam obtained from Raman shifting the pump beam by a characteristic Raman shift of the Raman-active medium.

The adjustable reflectors of any one of the second to the fourth aspects may be configured to translate a selected reflector along an optical axis of the resonator cavity, thereby to adjust the optical length of the resonator cavity. The optical axis of the resonator cavity may be defined to be coincident with a resonating optical mode of the resonator cavity.

The adjustable reflectors of any one of the second to the fourth aspects may be configured to adjust the length of the resonator cavity by a length equivalent to a round-trip time difference of +/−20 picoseconds for the Raman converted light in the resonator cavity.

The Raman laser of any one of the first to the fourth aspects may be a continuous-wave mode-locked Raman laser.

In any one of the second to the fourth aspects, each of the coupled resonator cavities may be adapted to resonate a frequency of light corresponding to a Stokes frequency of the Raman-active medium with respect to the frequency of the pump beam. The coupled resonator cavities may be partially coincident, wherein the resonator mode and/or the optical axis of each of the coupled resonator cavities may be spatially coincident in a portion of the cavities of the laser system.

The pump beam of any one of the first to the fourth aspects may be provided by a mode-locked pump source. The pump source may be a continuous wave mode-locked pump source. The pump source may comprise pump laser including a pump resonator cavity, wherein the pump resonator cavity is coupled with the resonator cavity. At least a portion of the resonator cavity may comprise at least a portion of the pump source resonator cavity in a coupled-cavity arrangement.

The pump beam in any one of the first to fourth aspects may be adapted to pump the resonator synchronously and may be provided by a pump source selected from the group of: Nd-doped lasers operating at their fundamental wavelengths (e.g. 1.06 μm or 1.3 μm) or second or third or fourth harmonics, of the fundamental beam, Ti:Sapphire lasers, other rare-earth or transition metal ion lasers, argon lasers, dye lasers, optical parametric oscillators, semiconductor lasers including optically-pumped semiconductor lasers including optically-pumped vertical external-cavity surface-emitting laser (VECSEL) sources, and fibre lasers. The pump source may be Q-switched pump source. The pump source may be a mode-locked pump source. This group of pump sources is not exclusive and alternative pump sources to those listed above as would be appreciated by the skilled addressee may also be used.

The system of any one of the first to the fourth aspects may be a synchronously pumped Raman laser system.

In the system of any one of the first to the fourth aspects, the pump source may comprise a pump laser including a pump resonator cavity, wherein the pump resonator cavity is coupled with the resonator cavity of the Raman laser system.

The system of any one of the first to the fourth aspects may provide a pulsed output beam comprising pulses of between 0.05 and 40 picoseconds pulse width. Alternatively, the output beam may comprise pulses of between 1 and 40 picoseconds pulse width, between 1 and 20 picoseconds pulse width, between 1 and 10 picoseconds pulse width, between 1 and 5 picoseconds pulse width, between 50 and 1000 femtoseconds pulse width, or between 50 and 200 femtoseconds pulse width.

The output reflector of any one of the first to the fourth aspects may be partially transmitting at the Raman-converted frequency. The output reflector may be up to about 80% transmitting in at the Raman-converted frequency. The output reflector may alternatively be up to about 90% transmitting in at the Raman-converted frequency. Greater then about 10% of the Raman-converted frequency may be resonated within the resonator cavity. In some arrangements, the laser system may be a high gain laser system. The gain of the laser system may be greater than 3, greater than 5, or greater than 10. The gain of the laser system may be between about 1 to 10, about 2 to 10, about 3 to 10, about 4 to 10, or about 5 to 10. In other arrangements, the laser system may be a low gain laser system with gain of between 0.01 (1%) and 1.

The system of the first aspect may further comprise a nonlinear medium located in the resonator cavity for frequency conversion of one or more beams resonating in the resonator cavity. The system of any one of the second to the fourth aspects may further comprise a nonlinear medium located in the resonator cavity for frequency conversion of one or more beams resonating in the one or more resonator cavities. The nonlinear medium may be configured for either second-harmonic generation or third-harmonic generation of a selected frequency resonating in the one or more resonator cavities. The nonlinear medium may be configured for either sum-frequency generation or difference frequency generation of at least two frequencies resonating in the one or more resonator cavities.

According to a fifth aspect, there is provided a method of providing a synchronously pumped Raman laser. The method may comprise providing a resonator cavity comprising a plurality of reflectors. At least one reflector may be adapted for outputting a pulsed output beam from the resonator cavity. The method may further comprise locating a solid state Raman-active medium in the resonator cavity to be pumped by a pulsed pump beam having a pump repetition rate, and for Raman-converting a pump pulse incident on the Raman-active medium to a resonating pulse at a Raman-converted frequency resonating in the resonator cavity. The method may further comprise providing a resonator adjustor for adjusting the optical length of the resonator. The method may further comprise adjusting the resonator adjustor to adjust the optical length of the cavity to match the round-trip time of the resonating Raman-converted pulse with the pump beam repetition rate such that the resonating pulse is coincident both spatially and temporally with a pump pulse in the Raman-active medium on each round trip, to Raman amplify the resonating pulse at the Raman-converted frequency in the Raman-active medium. At least one reflector may be an input reflector adapted for admitting the pulsed pump beam to the resonator cavity. Alternatively, the pulsed pump beam may be provided in a non-collinear pumping arrangement.

According to an arrangement of the fifth aspect, there is provided a method of providing a synchronously pumped Raman laser comprising: providing a resonator cavity comprising a plurality of reflectors, wherein at least one reflector is adapted for outputting a pulsed output beam from the resonator cavity; locating a solid state Raman-active medium in the resonator cavity to be pumped by a pulsed pump beam having a pump repetition rate, and for Raman-converting a pump pulse incident on the Raman-active medium to a resonating pulse at a Raman-converted frequency resonating in the resonator cavity; providing a resonator adjustor for adjusting the optical length of the resonator; and adjusting the resonator adjustor to adjust the optical length of the cavity to match the round-trip time of the resonating Raman-converted pulse with the pump beam repetition rate such that the resonating pulse is coincident both spatially and temporally with a pump pulse in the Raman-active medium on each round trip, to Raman amplify the resonating pulse at the Raman-converted frequency in the Raman-active medium.

At least one reflector may be an input reflector adapted for admitting the pulsed pump beam to the resonator cavity. Alternatively, the pulsed pump beam may be provided in a non-collinear pumping arrangement.

The adjustor may be a translator attached to a selected reflector of the resonator cavity. Adjustment of the optical length of the cavity may comprise translating the selected reflector with the translator along an optical axis of the resonator cavity, thereby to adjust the optical length of the resonator cavity. The translator may be configured to adjust the optical length of the resonator cavity by a length equivalent to a round-trip time difference of +/−33 picoseconds for the Raman converted light in the resonator cavity corresponding to approximately +/−1 cm in cavity length. The resonator adjustor of any one of the first to the fourth aspects may also be configured for fine adjustments of the length of the resonator cavity on the micrometer-scale (e.g. about 1 to 100 μm) or less (e.g. 500 to 1000 nm).

According to a sixth aspect, there is provided a method for providing a multiwavelength synchronously pumped Raman laser. The method may comprise providing a resonator cavity comprising a plurality of reflectors. The method may further comprise locating a solid state Raman-active medium in the resonator cavity, to be pumped by a pulsed pump beam and for Raman converting light in the resonator cavity incident thereon. The pump beam may have a pump repetition rate. The method may further comprise providing a dispersive element located in the resonator cavity for spatially dispersing resonating light in the cavity of different wavelengths to create two or a plurality of spatially separated resonating beams in the resonator cavity. The method may further comprise providing two or a plurality of adjustable reflectors located such that a respective spatially separated resonating beam is incident thereon to form two or a plurality of coupled resonator cavities. The method may further comprise adjusting each adjustable reflectors to adjust the optical length of the respective coupled resonator cavity as seen by its respective spatially separated beam thereby to match the round-trip time of the corresponding spatially separated beam with the pump beam repetition rate or the repetition rate of a beam resonating in the resonator cavity such that each of the spatially separated resonating beams are each coincident both temporally and spatially in the Raman-active medium on each round trip with a pump pulse or pulse of a resonating beam. At least one reflector may be an input reflector adapted for admitting the pulsed pump beam to the resonator cavity. Alternatively, the pulsed pump beam may be provided in a non-collinear pumping arrangement.

According to an arrangement of the sixth aspect, there is provided a method for providing a multiwavelength synchronously pumped Raman laser comprising: providing a resonator cavity comprising a plurality of reflectors; locating a solid state Raman-active medium in the resonator cavity, to be pumped by a pulsed pump beam having a pump repetition rate, and for Raman converting light in the resonator cavity incident thereon; providing a dispersive element located in the resonator cavity for spatially dispersing resonating light in the cavity of different wavelengths to create two or a plurality of spatially separated resonating beams in the resonator cavity; providing two or a plurality of adjustable reflectors located such that a respective spatially separated resonating beam is incident thereon to form two or a plurality of coupled resonator cavities, and adjusting each adjustable reflectors to adjust the optical length of the respective coupled resonator cavity as seen by its respective spatially separated beam thereby to match the round-trip time of the corresponding spatially separated beam with the pump beam repetition rate or the repetition rate of a beam resonating in the resonator cavity such that each of the spatially separated resonating beams are each coincident both temporally and spatially in the Raman-active medium on each round trip with a pump pulse or pulse of a resonating beam.

At least one reflector may be an input reflector adapted for admitting the pulsed pump beam to the resonator cavity. Alternatively, the pulsed pump beam may be provided in a non-collinear pumping arrangement.

The adjustable reflectors may each comprise a translator attached thereto. Adjustment of the optical length of each of the coupled resonator cavities may comprise translating each of the respective adjustable reflectors along an optical axis of the respective coupled resonator cavity as seen by the respective spatially separated beam, thereby to either lengthen or shorten the optical length of the resonator cavity as seen by each spatially separated beam in accordance with requirements.

According to a seventh aspect, there is provided a method of providing a multiwavelength Raman laser system. The method may comprise providing a plurality of reflectors defining at least two coupled resonator cavities. The at least two coupled resonator cavities may be adapted to resonate a different frequency of light. At least two of the plurality of reflectors may be adjustable reflectors. Each adjustable reflector may be associated with a respective coupled resonator cavity. The method may further comprise providing a solid state. Raman-active medium for Raman converting light in the resonator cavity incident thereon. The Raman-active medium may be located in each of the coupled resonator cavities. The Raman-active medium may be adapted to be pumped by a pulsed pump beam having a pump repetition rate. The method may further comprise providing a dispersive element located in the each of the coupled resonator cavities for spatially dispersing light of different frequencies to form at least two spatially separated beams. Each of the spatially separated beams may be of a frequency adapted to be resonated in a respective coupled resonator cavity. The method may further comprise independently adjusting each of the adjustable reflectors to adjust the optical length of a respective coupled resonator cavity to match the round-trip time of the corresponding spatially separated beam with the pump beam repetition rate or the repetition rate of a beam resonating in the resonator cavity such that pulses of light resonating in each of the coupled resonator cavities are each coincident both temporally and spatially in the Raman-active medium on each round trip with a pump pulse or pulse of a resonating beam. At least one reflector may be adapted to admit a pulsed pump beam having a pump repetition rate. Alternatively, the pulsed pump beam may be provided in a non-collinear pumping arrangement.

According to an arrangement of the seventh aspect, there is provided a method of providing a multiwavelength Raman laser system comprising: providing a plurality of reflectors defining at least two coupled resonator cavities adapted to resonate a different frequency of light, wherein at least two of the plurality of reflectors may be adjustable reflectors, each adjustable reflector associated with a respective coupled resonator cavity; providing a solid state Raman-active medium for Raman converting light in the resonator cavity incident thereon, the Raman-active medium being located in each of the coupled resonator cavities and adapted to be pumped by a pulsed pump beam having a pump repetition rate; providing a dispersive element located in the each of the coupled resonator cavities for spatially dispersing light of different frequencies to form at least two spatially separated beams, wherein each of the spatially separated beams may be of a frequency adapted to be resonated in a respective coupled resonator cavity; and independently adjusting each of the adjustable reflectors to adjust the optical length of a respective coupled resonator cavity to match the round-trip time of the corresponding spatially separated beam with the pump beam repetition rate or the repetition rate of a beam resonating in the resonator cavity such that pulses of light resonating in each of the coupled resonator cavities are each coincident both temporally and spatially in the Raman-active medium on each round trip with a pump pulse or pulse of a resonating beam.

At least one reflector may be an input reflector adapted for admitting the pulsed pump beam to the resonator cavity. Alternatively, the pulsed pump beam may be provided in a non-collinear pumping arrangement.

In any one of the fifth to the seventh aspects, the method may further comprise providing a nonlinear material in the one or more resonator cavities for frequency converting one or more frequencies of light in the one or more resonator cavities. The nonlinear medium may be configured for either second-harmonic generation or third-harmonic generation of a selected frequency resonating in the one or more resonator cavities. The nonlinear medium may be configured for either sum-frequency generation or difference frequency generation of at least two frequencies resonating in the one or more resonator cavities.

According to an eighth aspect there is provided a synchronously pumped continuous-wave mode-locked Raman laser system. The system may comprise a first resonator cavity adapted to admit a continuous wave mode-locked pump beam. The resonator cavity may further be adapted to convert the pump beam in a first solid state Raman-active medium to a first Raman-converted beam at a first converted frequency. The resonator cavity may further be adapted to output a portion of the first Raman-beam from the first resonator cavity. The first resonator cavity may comprise a first adjustor for adjusting the optical length of the first resonator cavity to match a round-trip time of the Raman-converted beam in the first resonator cavity to the repetition rate of the pump beam.

According to a first arrangement of the eighth aspect, there is provided a synchronously pumped continuous-wave mode-locked Raman laser system comprising a first resonator cavity adapted to admit a continuous wave mode-locked pump beam, convert the pump beam in a first solid state Raman-active medium to a first Raman-converted beam at a first converted frequency, and output a portion of the first Raman-beam from the first resonator cavity, the first resonator cavity comprising a first adjustor for, adjusting the optical length of the first resonator cavity to match a round-trip time of the Raman-converted beam in the first resonator cavity to the repetition rate of the pump beam.

According to a second arrangement of the eighth aspect, there is provided a synchronously pumped continuous-wave mode-locked Raman laser system according to the first arrangement, the system further comprising a second resonator cavity adapted to admit the first Raman-converted beam, convert the first Raman converted beam to a second Raman-converted beam in a second solid state Raman-active medium, and output a portion of the second Raman-converted beam from the second resonator cavity, the second resonator cavity comprising a second adjustor for adjusting the optical length of the second resonator cavity to match a round-trip time of the second Raman-converted beam in the second resonator cavity to the repetition rate of the first Raman-converted beam.

According to a third arrangement of the eighth aspect, there is provided a synchronously pumped continuous-wave mode-locked Raman laser system comprising a plurality of cascaded resonator cavities, each cascaded resonator cavity adapted to admit an beam outputted from a previous resonator cavity, converting the inputted beam in a solid state Raman-active medium in each cascaded cavity, and outputting a Raman-converted beam, each cascaded resonator cavity comprising an adjustor for adjusting the optical length of a corresponding resonator cavity to match a round-trip time of the Raman-converted beam resonating therein to the repetition rate of the inputted beam.

According to a ninth aspect, there is provided a synchronously pumped continuous wave mode-locked multiwavelength Raman laser system. The system may comprise a plurality of coupled resonator cavities, wherein each coupled resonator cavity is adapted to resonate a different frequency therein. The system may further comprise, a solid state Raman-active medium adapted to be pumped by a pump beam and located to be within each of the plurality of coupled resonator cavities. The system may further comprise a plurality of adjustors associated with a respective resonator cavity, each adapted to adjust the optical length of the respective cavity to match a round-trip time of a beam resonating therein to the repetition rate of the pump beam. At least one of the coupled resonator cavities may be adapted to output a portion of the beam resonating therein.

According to an arrangement of the ninth aspect, there is provided a synchronously pumped continuous wave mode-locked multiwavelength Raman laser system comprising a plurality of coupled resonator cavities, wherein each coupled resonator cavity is adapted to resonate a different frequency therein; a solid state Raman-active medium adapted to be pumped by a pump beam and located to be within each of the plurality of coupled resonator cavities; a plurality of adjustors associated with a respective resonator cavity, each adapted to adjust the optical length of the respective cavity to match a round-trip time of a beam resonating therein to the repetition rate of the pump beam; and wherein at least one of the coupled resonator cavities is adapted to output a portion of the beam resonating therein.

The Raman-active medium of any one of the first to the ninth aspects may be selected from the group of KGW (potassium gadolinium tungstate), KYW (potassium yttrium tungstate), Ba(NO₃)₂ (barium nitrate), LiIO₃ (lithium iodate), MgO:LiNbO₃ (magnesium oxide doped lithium niobate), BaWO₄ (barium tungstate), PbWO₄ (lead tungstate), CaWO₄ (calcium tungstate), other suitable tungstates or molybdates, diamond, silicon, GdYVO₄ (gadolinium vanadate), YVO4 (yttrium vanadate), LiNbO₃ (lithium niobate) and other suitable crystalline or glass materials which are Raman-active. The Raman active medium may be a Raman-active optical fibre.

The nonlinear medium of any one of the first to the seventh aspects may be selected from the group of LBO, LTBO, BBO, KBO, KTP, RTA, RTP, KTA, ADP, LiIO3KD*P, LiNbO3 and periodically-poled LiNbO3 or alternative suitable nonlinear medium.

The pump beam in any one of the first to ninth aspects may be adapted to pump the resonator synchronously and may be provided by a pump source selected from the group of: Nd-doped lasers operating at their fundamental wavelengths (e.g. 1.06 μm or 1.3 μm) or second or third or fourth harmonics, of the fundamental beam Ti:Sapphire lasers, other rare-earth or transition metal ion lasers, argon lasers, dye lasers, optical parametric oscillators, semiconductor lasers including optically-pumped semiconductor lasers including optically-pumped vertical external-cavity surface-emitting laser (VECSEL) sources, and fibre lasers. The pump source may be Q-switched pump source. The pump source may be a mode-locked pump source. This group of pump sources is not exclusive and alternative pump sources to those listed above as would be appreciated by the skilled addressee may also be used.

### BRIEF DESCRIPTION OF THE DRAWINGS

Arrangements of the Raman laser system will now be described, by way of an example only, with reference to the accompanying drawings wherein:

FIGS. 1A and 1B are schematic arrangement of a synchronously pumped Raman laser system as disclosed herein;

FIG. 1C is an alternative arrangement of the synchronously pumped Raman laser systems disclosed herein utilising a non-collinear pumping arrangement;

FIG. 1D is a multiwavelength Raman laser system, formed from a series of cascaded synchronously pumped Raman laser systems as disclosed herein;

FIG. 2 is an exemplary arrangement of a synchronously pumped Raman laser system as disclosed herein;

FIG. 3A is a graph of the average output power as a function of cavity length detuning for the arrangement of FIG. 2;

FIG. 3B is a graph of the output pulse duration as a function of the cavity length detuning for the arrangement of FIG. 2, where traces above the main curve represent measured autocorrelation functions for different lengths;

FIGS. 4A and 4B respectively are graphs of the pulse duration and output power of the arrangement of FIG. 2 as disclosed herein;

FIG. 5 is a further arrangement of a synchronously pumped Raman laser system as disclosed herein;

FIGS. 6A and 6B respectively show graphs of the output power and pulse duration of a further arrangement of the arrangement of FIG. 5 as disclosed herein;

FIG. 7 is a series of graphs of pulse shape obtained from a numerical analysis of a synchronously pumped Raman laser as disclosed herein, both before and after the Raman crystal in the Raritan laser system, for three values of length detuning of the Raman laser cavity;

FIG. 8 is an arrangement of a multiwavelength synchronously pumped Raman laser as disclosed herein;

FIG. 9 shows a graph of the slope efficiencies for optimized resonators for 1st Stokes (open circles) and 2nd Stokes (open squares) generation in the multiwavelength Raman laser arrangement of FIG. 8;

FIG. 10 is a graph of shows a graph of the dependence of pulse duration and output power on the cavity length detuning for the first. Stokes output for the Raman laser system of FIG. 8;

FIG. 11 is a graph of the output power and pulse duration as a function of 2^{nd} Stokes cavity length for the Raman laser system of FIG. 8;

FIG. 12 is a further arrangement of a multiwavelength synchronously pumped Raman laser as disclosed herein;

FIG. 13A and 13B are schematic arrangements of example arrangements of coupled cavity synchronous pumped Raman laser systems as disclosed herein; and

FIG. 13C shows a possible adaptation of the systems of FIGS. 13A and 13B to for a multi-wavelength synchronously pumped ultrafast Raman laser system as disclosed herein.

### DEFINITIONS

The following definitions are provided as general definitions and should in no way limit the scope of the present invention to those terms alone, but are put forth for a better understanding of the following description.

Unless defined otherwise, all technical and scientific terms used herein have the same meaning as commonly understood by those of ordinary skill in the art to which the invention belongs. For the purposes of the present invention, the following terms are defined below.

The articles “a” and “an” are used herein to refer to one or to more than one (i.e. to at least one) of the grammatical object of the article. By way of example, “an element” refers to one element or more than one element.

The term “about” is used herein to refer to quantities that vary by as much as 30%, preferably by as much as 20%, and more preferably by as much as 10% to a reference quantity.

Throughout this specification, unless the context requires otherwise, the words “comprise”, “comprises” and “comprising” will be understood to imply the inclusion of a stated step or element or group of steps or elements but not the exclusion of any other step or element or group of steps or elements.

Although any methods and materials similar or equivalent to those described herein can be used in the practice or testing of the present invention, preferred methods and materials are described. It will be appreciated that the methods, apparatus and systems described herein may be implemented in a variety of ways and for a variety of purposes. The description here is by way of example only.

### DETAILED DESCRIPTION

Disclosed herein are systems, methods and apparatus for generating output in the yellow-orange spectral region that is more suited to applications requiring nJ pulse energies and CW pulse trains using crystalline Raman lasers systems synchronously pumped with CW mode-locked pump laser sources.

The present application describes laser systems and methods of operation of such laser systems comprising in general solid-state synchronously-pumped Raman lasers, in which the pump source may for example be any suitable pulsed pump source, such as for example either a tunable Ti:Sapphire laser or a neodymium-based laser. In other arrangements, the pump source may be a Raman laser system according to any one of the example Raman laser systems described herein in a cascaded conversion arrangement to higher order Stokes beams as discussed below. Raman lasers are a maturing technology ideal for efficient frequency conversion of lasers. Stimulated Raman shifting (SRS) is a non-linear process that shifts a pump wavelength to create a longer ‘Stokes’ wavelength. The frequency downshift depends on the particular Raman crystal chosen. In Raman lasers systems, the wavelength shifting may be cascaded to higher orders through suitable selection of system components and design, thereby generating the ‘second Stokes’, ‘third Stokes’ etc. Normally the Stokes wavelengths are resonated in an optical cavity giving more efficient conversion, high beam quality, and greater control over the cascading process.

Raman lasers have several key strengths. Unlike OPOs, the lasers are not at all sensitive to crystal temperature or angle. This makes them simple and robust for commercialisation. The Raman crystals do not degrade with time; indeed some of the best Raman materials are standard commercial laser materials such as yttrium vanadate (YVO₄). The Raman process is not wavelength dependent, so the system may be pumped using infrared, visible or even ultraviolet pump lasers. The Stokes shift can be chosen to be large or small by selecting from a range of well-tested Raman crystals, for example including KGW (potassium gadolinium tungstate), KYW (potassium yttrium tungstate) barium nitrate, lithium iodate, barium tungstate, lead tungstate calcium tungstate, other tungstates and molybdates, diamond, gadolinium vanadate and yttrium vanadate and other crystalline materials which are Raman-active.

Also, within a single Raman laser, the laser system can be designed to enable rapid switching between efficient generation of any of the cascaded Stokes wavelengths. Even greater flexibility can be achieved by also using standard frequency doubling (SHG) and sum-frequency generation (SFG) to mix the Raman wavelengths. For example, mixing the wavelengths from a cascaded Raman laser pumped at 1064 nm, gives access to the entire hard-to-reach 550-700 nm region from a single laser, illustrated below. This frequency mixing can be done efficiently inside the Raman laser, and can be switched rapidly to choose between the potential output wavelengths.

Compared to continuous wave lasers, such as that disclosed in the inventor's international patent application no. PCT/AU2007/000433, the contents of which are wholly encompassed herein by cross reference, ultrashort Raman lasers are more complex and the design considerations are quite different. A simple resonator is not helpful for such ultrashort pulsed systems: the pump pulses are so short that a resonating cavity field cannot build up. With no resonator, single-pass Raman lasers suffer from low beam quality, and poor control over the cascading process.

To overcome this issue, the presently disclosed systems use the technique of synchronous pumping, which has previously been investigated in the regime of very large Q-switched mode-locked pump sources [see for example Straka et al., Opt. Comm. 178, 175-180 (2000), or Chunaev et al., Laser Phys. Lett. 5, 589-592 (2008)], where the round trip time of the Raman resonator is matched to the time between the pump pulses. In this way the Stokes field(s) may be resonated within the cavity, with each successive pump pulse amplifying the Stokes pulse inside the resonator. As will be discussed in detail below, these lasers operate in the “transient regime” of SRS where the pulse durations are shorter than the material response time, and theoretical models are required to understand the dynamics of the interactions between the light fields and materials involved.

Disclosed herein are varied arrangements of synchronously pumped cw mode-locked Raman lasers systems including:
A single wavelength synchronously pumped Raman laser operating at 559 nm, pumped by a frequency-doubled mode-locked Nd:YVO₄ laser. The disclosed exemplary laser arrangement generated CW mode-locked output at an overall (green-yellow) efficiency of 25.6%. Compression of the 10 ps pump pulses down to 3.2 ps output pulses was observed when the cavity length was slightly longer than for perfect synchronization.
A multiwavelength synchronously pumped mode locked Raman laser system generating two different wavelengths using cascaded Raman shifting in a multi-cavity arrangement. The disclosed exemplary arrangement produced 2.4 W at 559 nm and 1.4 W at 589 nm, with slope efficiencies up to 52% for both the First and the Second Stokes wavelengths. The peak power of the generated pulses was almost as high as the pump pulses as a consequence of pulse shortening.
A multiwavelength synchronously pumped mode locked Raman laser system generating three or more different wavelengths using cascaded Raman shifting in a multi-cavity arrangement.
Systems and methods for selectable multiwavelength synchronously pumped mode locked Raman laser systems generating one or more selectable output wavelength(s) using combination(s) of cascaded Raman shifting and nonlinear frequency conversion techniques.
Continuously tunable pumped mode locked Raman laser systems.

Such laser systems have the advantages of being able to be designed to provide a family of ultrafast Raman laser systems that can access the entire UV to infrared range, with multi-wavelength and selectable-wavelength outputs, and, for laser systems with variable pulse compression. This family of laser systems has far-reaching impact on a wide variety of applications, including but certainly not limited to biophotonics, and two-photon microscopy. For example two-photon microscopy is an established tool used for 3D imaging of cells, especially within thick tissue samples and where avoidance of damage to living samples is required. Another application of two-photon microscopy is the spatially-resolved photorelease of caged compounds, referred to as molecular uncaging. This is a quantitative technique for highly-localised release of chemicals or drugs, useful for studying for example neurological disorders and drug uptake. For these applications, the gaps in the spectral coverage of the existing ultrafast sources are restricting research possibilities. Significantly, it is the yellow/red region of the spectrum, that is of most interest and which the presently disclosed laser systems are particularly suited.

Other advantages and applications which will benefit from the laser systems disclosed herein include:

Enabling the use of native fluorophores (such as tryptophan, NADH and FAD) instead of introduced fluorescent labels. By eliminating the need for a compatible label, native fluorophores avoid the possibility of modifying the sample and simplify the imaging process. The main obstacle has been the required excitation wavelength—tryptophan has a peak single-photon excitation wavelength around 280 nm, which corresponds to a two-photon excitation wavelength in the yellow spectral region. The Raman approach will provide the necessary wavelengths.

Multi-photon flash photolysis for molecular uncaging. The uptake of this powerful two-photon based tool for quantitative cell physiology has been restricted by the availability of laser sources matched to the caging molecules. These typically have a single-photon uncaging response around 330 nm and hence the two-photon uncaging wavelength is around 660 nm. The Raman approach will provide the necessary wavelengths.

Ratiometric microscopy. Ratiometric microscopy, simultaneously using two excitation wavelengths, can be used to measure concentrations of chemical species. For example, tracking intracellular activity of Ca²⁺, vital for metabolism and signalling in living systems, can be accomplished by measuring the ratio of the fluorescence of a marker with two different excitation wavelengths. This application can benefit specifically from a laser system capable of providing dual-wavelength output. Raman lasers can simultaneously generate both of the required wavelengths, and so are an ideal and simple source for these types of measurements. For thick tissue Ca²⁺ monitoring, multi-photon methods are required and so the need for ultra-short pulsed laser sources with dual wavelength output in the yellow/orange region. A dual wavelength Raman laser as disclosed herein is capable of simultaneously generating both required wavelengths (around 680 nm and 720 nm) in this hard-to-reach region, and carry out ratiometric Ca²⁺ monitoring using the a suitable dye (for example the FURA-2AM dye).

Outside of biophotonics, wavelength-versatile ultrafast lasers will also lead to applications in other industries sectors. In display for example, wavelength-versatile ultrafast lasers offer reduced speckle, while another application of two-photon microscopy is micro-lithography targeting optical data storage.

### Ultrafast Raman Lasers

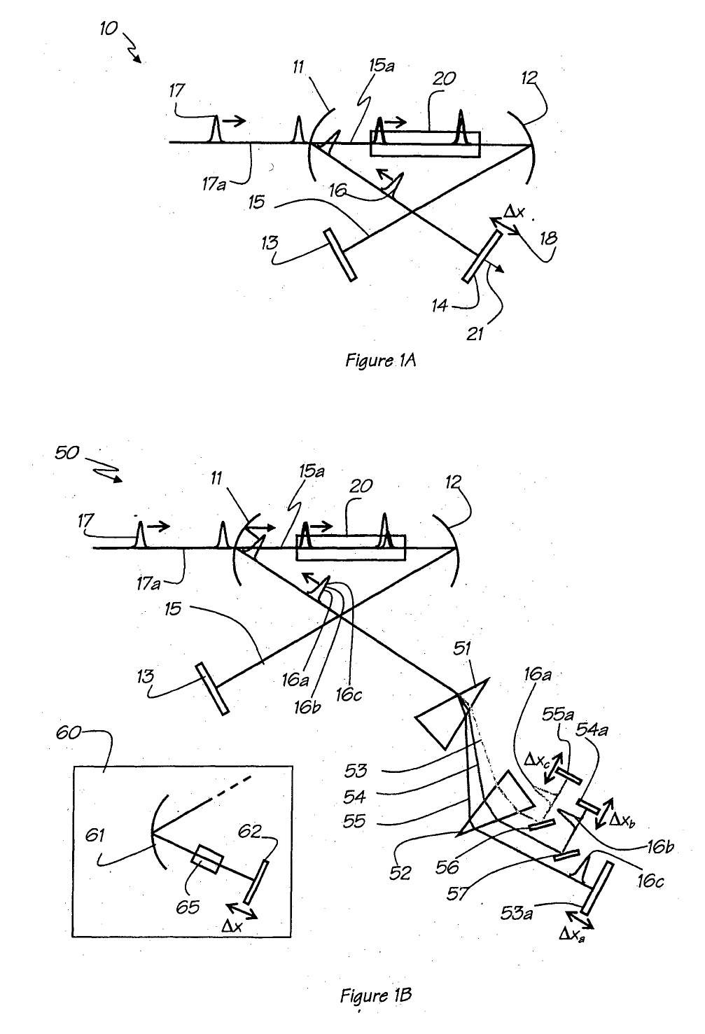

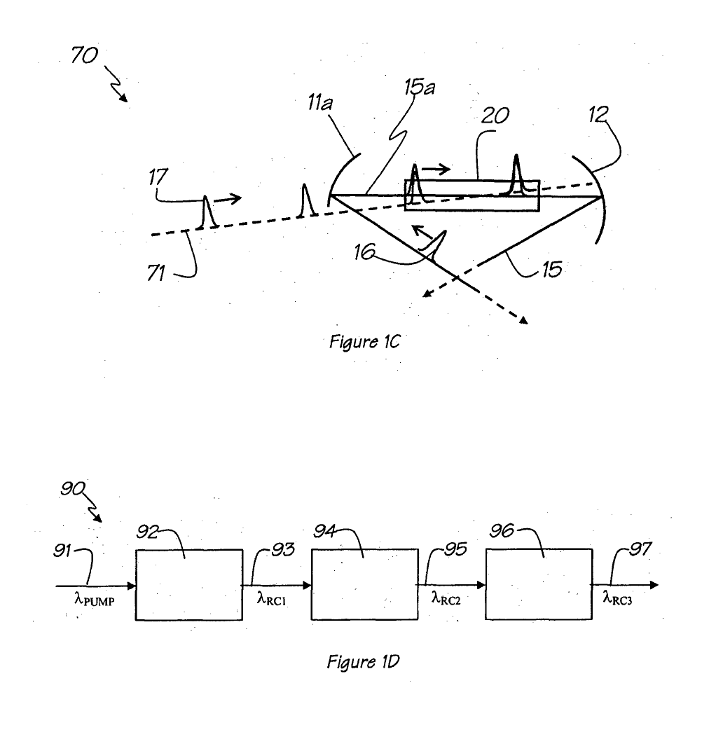

Referring to the FIG. 1A, an example arrangement of an ultrafast (picosecond/femtosecond) Raman laser system 10 is depicted schematically. Raman laser system 10 comprises a resonator cavity 15 defined by a plurality of reflectors. In the depicted arrangement four reflectors 11, 12, 13, and 14 are shown, however, it will be appreciated that a resonator cavity with only 3 reflectors may also be realised, wherein the 3-reflector cavity may comprise a single ‘long’ arm and have one of the ‘curved’ reflectors aligned as a retro-reflector (i.e. either of reflectors 11 or 12 of FIG. 1A). In further arrangements, more than four reflectors may also be employed (5, 6 or more) as will be appreciated by the skilled reader. In the present arrangement, at least one reflector (e.g. reflector 11) is configured as an input reflector adapted for admitting a pulsed pump beam 17 to the resonator cavity 15, wherein the pump beam has a known pump repetition rate. In this arrangement, the propagation direction 17a of the pump pulses is configured to be collinear with the resonator axis 15a in Raman-active medium 20 located in the resonator cavity 15. In alternate arrangements as discussed below, non-collinear pumping arrangements may also be used. Further, at least one reflector (e.g. reflector 14) is configured as an output reflector adapted for outputting a pulsed output beam 21 from the resonator cavity 15 at a frequency corresponding to a Raman shifted frequency of the pump beam. The output reflector 14 is at least partially transmitting at the Raman-converted frequency to permit a fraction of the resonating beam in resonator cavity 15 to exit the cavity and form the output beam 21. In other arrangements, a different resonator reflector (e.g. reflector 13) may alternatively be configured as an output reflector.

The solid state Raman-active medium (crystal) 20 is located in the resonator cavity 15 and positioned in the cavity 15 so as to be pumped by the pump pulses 17 of the pump beam. The pump beam is generated by an external pump source (not shown). The Raman active medium 20 is adapted for Raman converting the pump pulses 17 incident on the Raman-active medium 20 to a resonating pulse 16 at a Raman-converted frequency (first Stokes frequency) which resonates within resonator cavity 15.

The laser system 10 further comprises a resonator adjustor 18 adapted to adjust the optical length of the cavity 15. The resonator adjustor 18 is configured in particular arrangements to move a selected reflector (e.g. reflector 14) along the optical axis 15a of the resonator (where the optical axis is defined to be coincident with a resonant mode of the resonator 15) to adjust the optical length of the resonator cavity 15 as seen by the resonating pulses 16. In operation, the adjustment of the optical length of resonator 15 is performed to match the round-trip time of a pulse 16 resonating in the cavity 15 with that of the repetition rate of the pump pulses 17 such that each resonating pulse 16 is coincident both temporally and spatially with a pump pulse in the Raman-active medium 20 on each round trip of the cavity 15, to Raman amplify the resonating pulse at the Raman-converted frequency in the Raman-active medium 20. In the present arrangements, the resonator adjustor 18 is realised by attaching a resonator reflector (e.g. output reflector 14) to a linear translator, such that the reflector is able to be translated along the axis of the resonator cavity 15. This ‘detuning’ of the length of resonator cavity 15 length by a small distance, Δx, which may be wither a positive detuning to lengthen the cavity or a negative detuning to shorten the cavity, enables the resonating pulses 16 and the pump pulses 17 to be coincident in the Raman crystal 20 on each round trip of the resonating pulses 16 in a synchronously pumped arrangement. In this way, the resonating pulse 16 sees Raman gain from the coincident pump pulse 17 as it passes through the Raman crystal 20.

In other arrangements as will be described below, the Raman-active medium may also Raman-convert any resonating light pulses resonating in the cavity 15 (for example pulse 16) which are incident on the Raman crystal 20 to a higher order Stokes frequency in a cascaded Raman conversion.

Suitably the Raman-active medium of the laser system is a single crystal of KGW, LiIO₃, Ba(NO₃)₂ or other suitable Raman active material such as KDP (potassium dihydrogen phosphate), KD*P (deuterated), KTP, RTP, YVO₄, GdVO₄, BaWO₄, PbWO₄, lithium niobate, magnesium oxide doped lithium niobate, diamond, silicon and various tungstates (KYW, CaWO₄) and molybdate or vanadate crystals, or other suitable crystalline or glass materials which are Raman-active. The Raman active medium may be a Raman-active optical fibre. Other suitable Raman active crystals are described in the CRC Handbook of Laser or the text. “Quantum Electronics” by Pantell and Puthoff. The Raman-active materials diamond, MgO:LiNbO₃, KGW, LiIO₃ and Ba(NO₃)₂, YVO₄ and GdVO₄, are preferred, for at least the following reasons:
Diamond has very high thermal conductivity, large Raman shift (1332 cm⁻¹), and high Raman gain
MgO:LiNbO₃ has very short dephasing time (<0.5 ps) and as a consequence can enable substantial pulse compression/pulse shortening. Several Raman shifts are possible, including 256 cm⁻¹ and 628 cm⁻¹.
KGW is a biaxial crystal with a high damage threshold, and is capable of providing Raman shifts of 768 and 901 cm⁻¹.
Ba(NO₃)₂ is an isotropic crystal with a high gain coefficient (11 cm/GW with 1064 nm pump) leading to low threshold operation and can provide a Raman shift of 1048.6 cm⁻¹.
LiIO₃ is a polar uniaxial crystal with a complex Raman spectrum which depends on the crystal cut and orientation with respect to the pump propagation direction and polarisation vectors and can provide Raman shifts of between 745 cm⁻¹ and 848 cm⁻¹ (which are useful when targeting wavelengths for specific applications for example 578 nm which is useful for medical applications including ophthalmology and dermatology) but has a lower damage threshold (about 100 MW/cm²) compared with Ba(NO₃)₂ (about 400 MW/cm²). KGW has a far higher damage threshold of about 10 GWcm⁻².
YVO₄, GdVO₄, are uniaxial crystals which feature good thermal properties, high Raman gain coefficients and high damage threshold.
LiIO₃, YVO₄, and GdVO₄, all have good slope efficiencies (wherein the maximum slope efficiency is determined by the ratio of Stokes to fundamental photon energies, and the minimum set by the ratio of losses in the resonator cavity to the output coupling and other factors as would be appreciated by the skilled addressee) with optical to optical conversion efficiencies of 70-80% being reported for all three.

The laser system is preferably operated such that optical damage of the Raman active medium is avoided. Table 1 shows the Raman shifts for a range of example Raman-active media, and Table 2 shows the Raman shifts and corresponding Stokes wavelengths for several example Raman-active media.

TABLE 1
Raman shifts for selected Raman-active media

| Raman-active Crystal | Raman shift (cm⁻¹) |
|---|---|
| CaCO₃ | 1085 |
| NaNO₃ | 1066 |
| Ba(NO₃)₂ | 1046 |
| YVO₄ | 890 |
| GdVO₄ | 882 |
| KDP | 915 |
| NaBrO₃ | 795 |
| LiIO₃ | 822 and 770 |
| BaWO₄ | 926 |
| PbWO₄ | 901 |
| CaWO₄ | 908 |
| ZnWO₄ | 907 |
| CdWO₄ | 890 |
| KY(WO₄)₂ | 765 and 905 |
| KGd(WO₄)₂ | 768 |
| KGd(WO₄)₂ | 901 |
| NaY(WO₄)₂ | 914 |
| NaBi(WO₄)₂ | 910 |
| NaBi(MoO₄)₂ | 877 |
| Diamond | 1332 |

TABLE 2
Raman shifts and corresponding Stokes wavelengths for selected
Raman-active media with a pump wavelength of 1.064 μm

| | | 1^{st} Stokes | | 3^{rd} Stokes |
|---|---|---|---|---|
| | Raman | wavelength | 2^{nd} Stokes | wavelength |
| Crystal | shift (cm⁻¹) | (nm) | wavelength (nm) | (nm) |
| KGW | 768 | 1158 | 1272 | 1410 |
| KGW | 901 | 1176 | 1320 | 1500 |
| PbWO₄ | 911 | 1177 | 1316 | 1494 |
| Ba(NO₃)₂ | 1048 | 1198 | 1369 | 1599 |
| LiIO₃ | 745 | 1156 | 1264 | 1396 |
| Diamond | 1332 | 1239 | 1484 | 1851 |

### Multiwavelength Ultrafast Raman Lasers

The arrangement of FIG. 1A may be modified as shown schematically in FIG. 1B to provide a multi-wavelength ultrafast Raman laser system 50. The system 10 may, for example be modified to realise the multi-wavelength system 50 by removing output reflector 14 and extending the resonator cavity 15 to include a dispersive element, for example prism pair P1 51 and P2 52. The dispersive element spatially disperses resonating light in the resonator cavity of different wavelengths/frequencies to create a plurality of spatially separated resonating beams 53, 54 and 55. The system 50 further comprises a plurality of adjustable reflectors 53a, 54a and 55a, each aligned to resonate a respective one of spatially separated beams 50a, 50b and 50c, thereby to provide a plurality of different but coupled resonator cavities. In the present Raman system, the spatially separated beams 53, 54 and 55 of different frequencies correspond to successive Stokes orders of the pump beam 17 which are generated by a cascaded Raman conversion process in the Raman-active medium 20. The coupled cavities, each with an adjustable reflector, enables independent control over each cavity length by providing resonator adjustor to each of reflectors 53a, 54a and 55a, to enable adjustment of the cavity length seen by each of the resonating Stokes orders. Additional scraper reflectors 56 and 57 are also used as shown to enable ease of access to each of the spatially separated beams. Each of the adjustable reflectors 53a, 54a and 55a is adapted to adjust the optical length of a respective coupled resonator cavity as seen by its respective spatially separated resonating beam (53, 54 and 55 respectively) thereby to match the round-trip time of the corresponding spatially separated beam either: with the pump beam repetition rate of pump pulses 17; or the repetition rate of one or more beams of different frequency 16a, 16b and/or 16c resonating in a different but coupled resonator cavity; such that pulses of different frequencies, each resonating in a respective coupled resonator, are each coincident both temporally and spatially with each other and/or with a pump pulse in the Raman-active medium 20 on each round trip.

Example Raman laser system 50 depicts the resonating light being separated into three spatially separated beams corresponding to the First, Second and Third Stokes orders of the laser system and incident on reflectors 53a, 54a and 55a respectively. It will be appreciated that less or more reflectors may be used depending on the required wavelength the system is desired to be operated. For example, the laser may only be required to output the Second order Stokes light, in which case, reflector 55 and scraper reflector 56 may be removed. Individual cavities can be blocked if required, to change the cascading.

Preliminary work described in the examples herein has shown that very efficient operation can be achieved (more than 50% slope efficiency) and that it is possible to generate Stokes output pulses with durations shorter than the pump pulses (as short as 3 ps for a 10 ps pump laser [4]) cascaded Raman systems generating up to three Stokes wavelengths are described below.

It will be appreciated that the Raman lasers systems disclosed herein offer significant flexibility in the design of the output wavelength available from the system. This capability for wavelength flexibility arises from 1) choice of pump laser wavelength, 2) choice of Raman crystal, 3) resonator design and 4) intracavity frequency mixing. In these systems, the pump source is a critical choice, as it sets the initial pump wavelength from which each of the Stokes orders are generated in the Raman crystal, i.e. by frequency conversion by SRS in the Raman crystal by the Raman shift characteristic of the particular Raman medium chosen.

The presently described laser systems are capable of radically extending the range of wavelengths available from conventional ultrashort pulse lasers and enable simultaneous multiwavelength output from cascaded resonators. This is achieved using a cascaded resonator design to demonstrate lasers that can output several wavelengths simultaneously, either in a single output beam (through reflector 13 of FIG. 1B) or in separate beams (through one or more of reflectors 53a, 54a and 55a of FIG. 1B) in accordance with requirements. By engineering the reflectivity of these reflectors, the energy distribution between the resonating wavelengths may be controlled. Also, suitable selection of the Raman crystal 20 will enable various sets of output wavelength, for example YVO₄ or KGd(WO₄)₂ will provide output around 559 nm, 588 nm and 608 nm when pumped with a 532 nm pump source, while diamond will provide wavelengths around 573 nm, 620 nm and 675 nm when pumped using the same 532 nm pump source. Pumping the lasers systems with either ultraviolet (UV) or infrared (IR) pump sources will yield simultaneous outputs at say 373 nm, 392 nm and 414 nm (i.e. when pumped with a 355 nm pump beam), or 1177 nm, 1316 nm and 1495 nm (when pumped with a 1064 nm pump beam). The choice of Raman crystal impacts on the temporal characteristics, and these impacts are discussed herein along with studies of pulse compression.

The presently disclosed Raman laser systems are also capable of providing ultrafast tunable Raman lasers, for example when using a tunable pump source such as a Ti:Sapphire laser to synchronously pump the Raman laser system, and it is expected that tunable Stokes or second Stokes output at for example 867-1147 nm or 937-1272 nm respectively will be able to be obtained respectively at between about 20% to 30% overall efficiency. This concept can also be extended into the visible region of the spectrum, by pumping with the second harmonic of a Ti:Sapphire laser to obtain tuning ranges such as 417-543 nm, 433-573 nm, 470-639 nm with expected efficiency of about 10% to about 30% of the available pump power in the visible, or alternatively an efficiency of between about 10% and 15% of the available infrared pump power levels for instance using currently available pump sources.

In these tunable arrangements non-collinear pumping, therefore avoiding the need for a dichroic input reflector, may be used to allow full tuning of the pump beam, for example as depicted in FIG. 1C. Using currently available pump sources, it is envisaged that pulses down to about 100 fs at least will be obtainable, however, at these pulse lengths the SRS process is strongly transient and optimisation of the laser systems in this regime (fast materials such as BaNO3 will likely perform best), for either or both maximum output and how to get the shortest possible output pulses is likely to be non-trivial. Indeed, dispersion compensation may be required to counteract the group velocity dispersion (GVD) of the Raman crystal, particularly in a high-Q (i.e. high reflectivity on the resonator reflectors) and low-threshold configuration of the lasers systems. In a non-collinear pumping arrangement as described above with respect to FIG. 1C, the pump beam substantially overlaps in the Raman-active medium with the pulses resonating in the resonator cavity, but the pump beam is not exactly collinear with the resonating beams as they pass through the Raman-active medium.

The presently disclosed Raman laser systems are also readily adaptable for intracavity frequency mixing for increased wavelength options, and wavelength selectability, since intracavity sum frequency mixing can allow extremely efficient frequency-upconversion owing to the high intracavity fields in the resonator cavity.

Therefore, in a further arrangement as depicted schematically in the inset 60 of FIG. 1B, an ultra fast Raman laser system with the additional feature of intracavity nonlinear conversion to the systems of FIGS. 1A and 1B may be achieved, for example, by replacing reflector 13 with a curved reflector 61 and adding an additional reflector 62 which may also be a curved reflector, where the angle of the of the optical axis of the resonator formed by the addition of the two new reflectors is small to minimise astigmatism in the resonator mode. The combination of reflectors 61 and 62 is selected to provide an additional beam waist in the resonator cavity intermediate reflectors 61 and 62 (or alternatively, reflector 62 may be a plane reflector in which case the new beam waist will be located at reflector 62). To achieve the nonlinear conversion, at least one nonlinear medium 65 is placed in the resonator cavity at the new beam waist formed by reflectors 61 and 62. The nonlinear medium 65 may be a solid state medium and may be a selected to provide either harmonic conversion (e.g. second harmonic generation) of a selected wavelength resonating in the cavity 15 or to provide either sum or difference frequency mixing between two or more resonating wavelengths as would be appreciated by the skilled addressee. A further arrangement (not shown) would simply be to select a reflector 13 to provide a beam waist intermediate the reflector 13 and reflector 12, and to place the nonlinear medium 65 at this new beam waist as above. In a further arrangement still the cavity may be configured for more than one nonlinear medium. For example, the reflector 61 may be selected to provide beam waists in both arms intermediate reflectors 61 and 62, and also intermediate reflectors 61 and 12 and to place a nonlinear medium at each of the new beam waists. Further similar arrangements as would be appreciated by the skilled addressee are envisaged to also be encompassed in the present arrangements.

Furthermore, controlling the angle of the nonlinear medium 65 can control the Raman cascade and rapidly switch the output wavelength. Additional complexities for this scheme include the group velocity walk-off, and the fact that cascaded Stokes pulses are not necessarily completely temporally overlapped; here the ability to control separate resonator lengths (i.e. using reflectors 53a, 54a and 55a) is extremely valuable. Using standard materials such as LBO (for visible generation) or BBO (for UV generation) placed at resonator cavity as described above efficient systems can be realised where a user can select between several visible wavelengths (e.g. 559 nm, 588 nm and 608 nm using KGW or around 573 nm, 620 nm and 675 nm using diamond) from an infrared Raman laser. Note the difference between simultaneous output (where the output energy is shared between laser wavelengths) and selectable output (where the output energy is channelled into one selectable wavelength, via configuring the LBO/BBO crystal). This scheme is also applicable to selectable UV wavelengths from Raman lasers pumped at 532 nm, in which the selectable wavelengths could for example be 373 nm, 392 nm and 414 nm.

Further arrangements of the synchronously pumped Raman laser systems 10 and 50 may alternatively employ a non-collinear pumping arrangement 70 as depicted in FIG. 1C. In such a non-collinear pumping arrangement, the pump beam is not collinear with the resonating beam in the Raman-active medium. The pump beam pulses 17 substantially overlap in the Raman-active medium 20 with the pulses 16 resonating in the resonator cavity 15, but the propagation direction 71 of the pump beam is not exactly collinear with the optical axis 15a of the resonator cavity 15 through the Raman-active medium but rather at an angle 72 to the optic axis. As before, the optical length of the resonator cavity 15 is adjusted such that the round-trip time of pulses 16 resonating in the cavity 15 is matched to the repetition rate of the pump pulses 17 such that each resonating pulse 16 is coincident both temporally and spatially with a pump pulse 17 in the Raman-active medium 20 on each round trip, to Raman amplify the resonating pulse 16 at the Raman-converted frequency in the Raman-active medium 20.

The advantage of a non-collinear pumping arrangement as depicted in FIG. 1C is that the pump pulses can be configured to pass by the resonator reflectors rather than through one of the reflectors. For example, as depicted in FIG. 1C the pump pulses 17 pass beside resonator reflector 11a. Therefore, the requirements of the resonator reflectors (particularly that of reflector 11a in the present example) may be relaxed as there is no need for an input reflector which must be configured for high transmission of the pump pulses 17 as well as high reflectivity for the resonating pulses 16. It will be appreciated that a non-collinear pumping arrangement as depicted in FIG. 1C may be utilised for each of the laser systems disclosed herein in accordance with requirements

In a further example arrangement 90 of a multiwavelength Raman laser system, the Raman laser system may be formed from a series of cascaded Raman laser systems as depicted in FIG. 1D. In this example arrangement 90, each of the successive cascaded stages 92, 94 and 96 may for example be a Raman laser system similar to that of laser system 10 (of FIG. 1A) although other arrangements as disclosed herein or equivalents may be substituted for each of the stages as required depending on the desired output wavelength from each stage. The pump source of the first stage may be an external pump source such as for example either a tunable Ti:Sapphire laser or a neodymium-based laser, however the pump source for each successive stage is the output Raman-converted beam from the previous stage. In this cascaded system 90, the pump beam with wavelength λ_{PUMP} 91 is input to the first stage 92 and Raman converted to a first Raman converted beam 93 with wavelength λ_{RC1} which is output from the first stage 92. The second stage 94 accepts the first Raman-converted beam 93 and Raman converts it to a second Raman converted beam 95 wavelength λ_{RC2} which is output from the second stage 94. Similarly, a third stage 96 accepts the second Raman-converted beam 95 and Raman converts it to a third Raman converted beam 97 wavelength λ_{RC3} which is output from the second stage 94, and so on. In each stage, the Raman-active medium may be the same as in each other stages, such that each of the input beams is shifted by the same, Raman-shift. In this case, each of the beams with wavelengths λ_{RC1} λ_{RC2} and λ_{RC3} will be at the first, second and third Stokes Raman converted wavelengths of the pump beam λ_{PUMP}. Alternatively, the Raman-active medium in each stage may be a different Raman-active medium to achieve a different Raman-frequency shift in each stage. It will of course be appreciated that the reflectors of each stage 92, 94, and 96 etc are configured to input the respective input beam and output the respective Raman-converted beam. For example, the input reflector (not shown) of stage 94 is adapted to input the first Raman converted beam at wavelength λ_{RC1}, the resonator reflectors (not shown) of stage 94 are adapted to resonate light at the wavelength of the second Raman converted beam at wavelength λ_{RC1}, and the output coupler (not shown) of stage 94 is adapted to output a portion of the resonating beam at wavelength λ_{RC1}, and similarly for each successive stage.

### Raman Laser Pulse Compression

The dynamics of ultrafast Raman lasers are complex due to two key effects: firstly SRS is non-instantaneous, naturally leading to higher gain for the trailing edge of Stokes pulses; secondly, the group velocity is different for pump and each Stokes wavelength as they propagate through the Raman crystal. These effects lead to the length of the Raman laser cavity having a strong effect on the efficiency and pulse shape of the Stokes pulses. Indeed substantial pulse shortening was seen in some circumstances while maintaining efficient operation. Similar compression has been observed in synchronous OPOs, but in the present case there is the added complication of the importance of the non-instantaneous nature of SRS in the picosecond regime.

Disclosed herein are studies of the effect of using different Raman materials to achieve higher degrees of pulse compression, with the ultimate goal of compressing picosecond pulses into the femtosecond domain. The dephasing time of the Raman media is found to be a critical parameter which varies by an order of magnitude between materials, from ˜10 ps for BaWO₄, to 200 fs for LiNbO₃. Group velocity dispersion and cascading also impact on pulse compression. Preliminary work described in the Examples below indicate that fine adjustment of the cavity length can give rise to an ultrafast laser system with selectable and/or variable pulse duration.

Additionally, a counter-propagating ring laser design may also be employed for increased pulse compression, using an opto-isolator to force unidirectional operation—the Raman process has similar gain in the backwards and forwards direction, and early signs from simulations show that extreme pulse compression may be realised in this way.

Disclosed herein also is a numerical model of the laser systems using a finite difference model, modelling field amplitudes, the fully-general transient stimulated Raman scattering equations, and including group velocity walk-off. This modelling provides insight into the underlying physics, guides experiments to optimum regimes, and provides excellent agreement with experimental observations as will be seen in the following Examples.

### Repetition Rate Multiplication

The Raman laser system as described herein may also be modified in additional arrangements depending on the requirements on the output pulses. For example, by having the Raman resonator cavity shorter to provide for a round-trip time less than that of the pump repetition rate, the Raman laser may generate output pulses at a higher repetition rate than the pump source. For example, if the Raman resonator cavity is configured with an optical length to provide a round-trip time half the length of the pump repetition rate, the Raman laser will operate at twice the repetition rate of the pump source. Alternatively, a Raman resonator cavity with a round-trip time two-thirds the pump repetition rate, the Raman laser will operate at three times the repetition rate of the pump. For ¾-length, the Raman laser system will operate at four times the rep rate, and so on. Other rational fractions of the pump repetition rate also produce repetition rate enhancements in the operation of the Raman laser system. Such increases in the repetition rate can be useful for applications such as scanning microscopy, where higher repetition rates allow for faster and finer, spatial scanning. For example, using an 80 MHz pump laser and a Raman cavity of ¾ the length, the Raman laser system will operate at a repetition rate of 320 MHz, and so the scanning microscope can sample points at four times the speed—either sampling an area in a quarter of the time, or sampling at double the resolution in the x and y directions.

### EXAMPLES

### Example 1

### Ultrafast Synchronously Pumped Raman Laser System

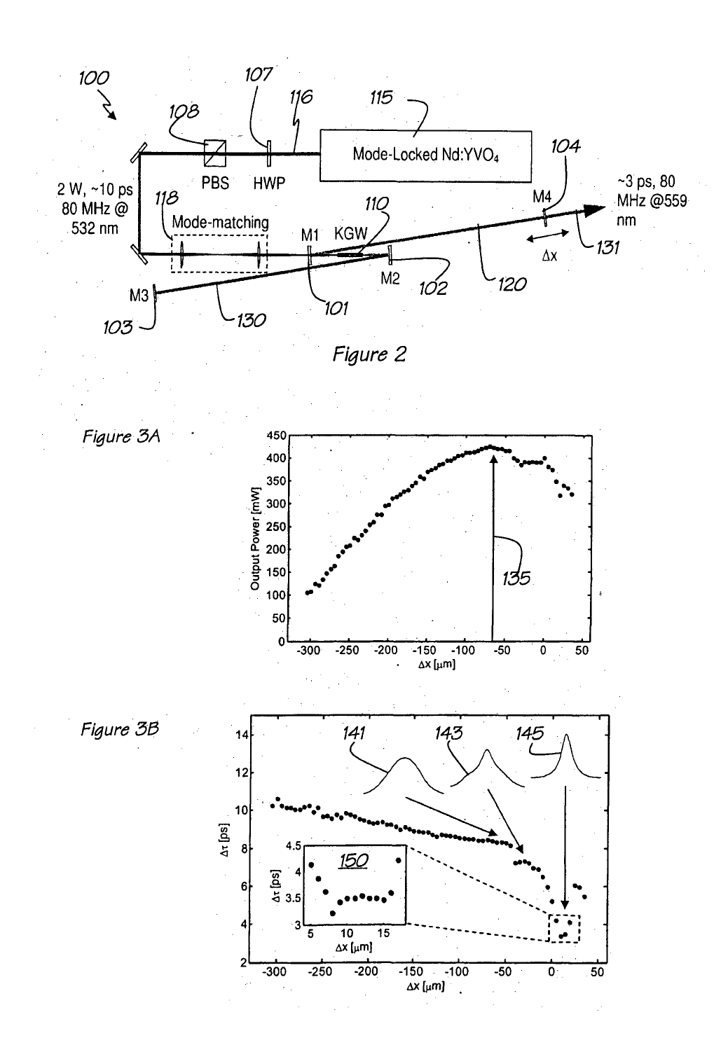

In the present example, a single wavelength synchronously pumped Raman laser system 100 is disclosed schematically in FIG. 2, where HWP 107 is a Half Wave-Plate @532 nm; PBS is a polarizing beam splitter 108; and Δx represents the possible cavity detuning by translating output reflector M4 104 along the axis of the resonator cavity 120. A mode-matching telescope system 118 was also employed to adjust the beam diameter of the pump beam 116 in Raman crystal 110 for mode-matching considerations i.e. to match the beam size of the pump beam in the crystal 110 with the size of the cavity mode at the position of the Raman crystal 110.

In the presently described example, the laser system 100 of FIG. 2 comprises a 50-mm-long KGW Raman crystal 110 as the stimulated Raman scattering (SRS) gain medium. The Raman crystal 110 was antireflection (AR) coated at 532 nm. The crystal 110 was oriented such that the pump beam 116 from a mode-locked Nd:YVO4 pump laser 115 propagated along the Nₚ axis of the KGW Raman crystal 110. A four reflector z-fold cavity was employed comprising reflectors M₁ 101, M₂ 102, M₃ 103, and M₄ 104. In the present arrangement, reflector M₁ 101 was selected to be a dichroic input reflector with a radius of curvature (ROC) of 20 cm; M₂ 102 was selected to be a curved reflector with 20 cm ROC and which is highly reflective at the wavelength (559 nm using a pump beam with wavelength of 532 nm) of the Raman shifted resonating light 130 in the resonator cavity 120; M₃ 103 was selected to be a flat (plane) high reflector at the resonating wavelength; and M₄ 104 was selected to be an output reflector (output coupler) with approximately 5% transmission at the wavelength of the resonating Raman shifted light 130.

The reflectors M₁ 101 and M₂ 102 were separated by approximately 23 cm. This reflector separation formed a resonator mode waist of radius of approximately 33 μm at the centre of the KGW Raman crystal 110, matching the beam waist of the pump beam 116 in the Raman crystal 110. The cavity 120 was optimized in the present arrangement to achieve the minimum lasing threshold. The angle of the z-fold cavity 120 was set as small as possible (at about 4 degrees in the present example) to minimize the astigmatism of the cavity mode as much as possible (of course, smaller angles would reduce this astigmatism in the resonator further as would be appreciate by the skilled addressee). Reflector M₁ 101 was selected to be a dichroic reflector with about 90% transmission at 532 nm to permit efficient pumping of the Raman crystal 110 and high reflectivity at the Raman wavelength 559 nm. While the present laser system 100 was designed for the output Stokes light 131 to be output from resonator 120 through output reflector M₄ 104, which in the present arrangement had approximately 5% transmission at the first Stokes wavelength of 559 nm (from the 532 nm pump beam due to the characteristic Raman shift of the KGW Raman crystal 110), there was also some leakage of the Raman-shifted first Stokes light 130 through the other reflectors 101, 102 and 103 of resonator 320. Accordingly, the output powers reported in this example are the sum of the powers exiting through the various reflectors M₁-M₄ at the first Stokes wavelength. It will be readily appreciated that it is possible to fabricate reflectors with close to ideal performance for example using ion-beam-sputtering coating technology), and so the total reported output power at the first Stokes wavelength could be easily achieved in a single beam 131 in an optimized arrangement.

In the present example, the pump source 115 was a frequency-doubled CW mode-locked Nd:YVO₄ laser (Spectra-Physics Vanguard 2000-HM532). The 2 W pump radiation was directly focused through M₁ 101 into the KGW Raman crystal 110, matched to the cavity mode size by two mode-matching lenses 118 (f₁=20 cm, f₂=15 cm). The pump pulse duration was 10 ps, with an 80 MHz repetition rate. The pump beam 116 was polarized and the Raman crystal 110 was configured such that the polarized light was aligned with the Nₘ axis of the KGW Raman crystal 110 to match the 901 cm⁻¹ Raman shift in the KGW crystal, corresponding to a conversion of 532 nm pump light 116 to 559 nm first Stokes light 130 (resonating in resonator 120) and 131 (output from resonator 120).

The average output power and the temporal autocorrelation function of the laser system 100 were measured as a function of cavity length detuning, Δx, as seen in FIGS. 3A and 3B. The cavity length detuning Δx is defined herein as the difference in the length of resonator 120 from the cavity length corresponding to the minimum threshold for laser operation, so that Δx=0 corresponds to perfect synchronization of the pump pulses and the resonating Raman shifted light 130 such that they overlap in the Raman crystal 110 at each round trip of the resonating pulse. For positive values of Δx, the resonating Stokes pulse 130 in the cavity 120 was slightly lagging the pump pulse 116 on each round trip, whereas when Δx was negative, the resonating Stokes pulse 130 preceded the pump pulse 116. The detuning Δx was performed by changing the position of M₄ 104 with a high precision translation stage (not shown) along the optical axis of the resonator cavity 120.

The dependence of the output power on cavity length is shown in FIG. 3A and, as can be seen, the maximum output power 135 was observed for a cavity detuning of Δx=−60 μm. The output power dropped off quickly for Δx >−60 μm, and decreased slowly for Δx<−60 μm. The measured beam quality (using a DataRay Inc. BeamScope P8) of the Raman shifted output beam 131 was observed to have an M-squared value of M²<1.05, which was slightly better than that of the pump beam 116 which had a beam quality of M²=1.2.

FIG. 3B shows the output pulse duration measured as a function of cavity detuning, using a commercial non-collinear second harmonic autocorrelator (Femtochrame Research Inc. FR-103XL). The traces 141, 143 and 145 above the main curve represent measured autocorrelation functions for different cavity lengths. Under conditions of maximum output power, the Stokes pulse duration was approximately 8.5 ps, compared to the pump pulse duration of 10 ps. For larger Δx, however, substantial shortening of the output pulses was observed, with the minimum pulse duration of 3.2 ps being observed when the cavity length was detuned to +8 μm, and the pump was set to maximum power of 1.6 W. A magnified view of this section of the plot is shown inset 150 in FIG. 3B. The determination of the pulse duration Δτ from the autocorrelation traces assumed a Gaussian pulse shape for all Δx. However, changes in shape of the traces were observed as the cavity was detuned. For cavities with Δx<−50 μm or Δx>10 μm, the autocorrelations were close to Gaussian. For the shortest pulses the autocorrelation was peaked more strongly, consistent with a sech-squared or single-sided-exponential pulse shape. Using those fittings would retrieve pulse durations shorter than depicted in FIG. 3A, dropping to a minimum of under, 3 ps. Moving away from the position of maximum compression, the autocorrelation showed a growing pedestal, responsible for the discontinuity in the measured pulse duration at a cavity length detuning of about −45 μm.

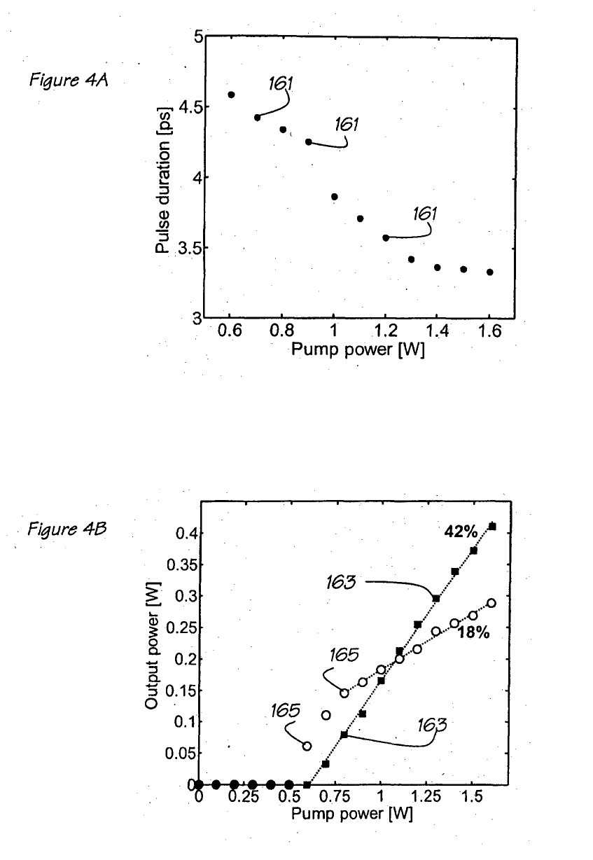

FIG. 4A shows the dependence of pulse duration on pump power of the laser system 100. For each measurement 161 of the average pulse duration at each value of the pump power, the cavity length was adjusted for optimum pulse compression. For lower pump powers, the best compression was achieved with a detuning closer to Δx=0. The pulse duration decreased rapidly to below 3.5 ps as the power was increased, but showed little further shortening as the pump power was increased from 1.4 W to 1.6 W.

FIG. 4B shows a graph of the average output powers for two different regimes; (i) cavity detuned for maximum output power (filled squares 163), and (ii) cavity detuned for shortest pulse duration (open circles 165). When operating in the first regime, the maximum CW output power was 410 mW for an incident power of 1.6 W, reaching a maximum green to yellow optical conversion efficiency of 25.6%. The slope efficiency for this case was 42%. For operation at minimum pulse duration in the second regime, the maximum measured output power was 290 mW, which is an optical conversion efficiency of 18%. However, the slope efficiency in this second regime showed a significant drop when the pump power was >0.9 W. This change in slope is attributed to the effects of the pulse compression in the oscillator, as discussed below. The lowest lasing threshold measured was for Δx=0 (by definition), where the pump power was 360 mW. No cascading of the Raman conversion to second or higher Stokes order was observed, likely due to the high 98% round-trip cavity losses at the second-Stokes wavelength.

### Discussion

The key feature of the results presented in the present example is the very sensitive conditions required for pulse shortening, with cavity detunings over a range of just ˜80 μm compared to the spatial extent of the 10 ps pump pulse of about 3 mm. This sensitivity is very different to the operation of the systems reported by different groups that use crystalline and gaseous picosecond Raman oscillators synchronously pumped by Q-switch mode-locked lasers, which generate trains of typically 20-40 separate ps pulses. In those experiments the Stokes field was built up from noise in just a few tens of round-trips. This required a gain of hundreds of percent per round trip with strong reshaping of the Stokes pulse on each pass, resulting in much more relaxed bounds on the tolerated cavity detuning. As those systems relied on the high, gain produced in the Raman medium, much higher pump peak powers were required for effective compression, and so picosecond pulses with energies of up to 1 mJ were used.

In the case of a continuous train of mode-locked pulses as in the present example, the round trip gain was of the same order as the output coupling. This regime is much closer to that in previous work on synchronously pumped optical parametric oscillators (OPOs) [for example, see Rauscher, et al., Opt. Lett. 20, 2003-2005 (1995)], and many similarities in the operating characteristics of the present Raman laser system with that of the OPO in Rauscher, et al are seen. For example, the pulse compression occurs within a very small region at slightly positive detunings; and, for longer and shorter cavities, the compression is much smaller, with a longer plateau on the size corresponding to negative detuning. The compression of pulses in synchronously pumped OPO's is produced by the group velocity mismatch between the pump and the generated pulses, yielding compression factors greater than 20. In such prior experiments with OPO's, it was believed that the idler overtook the pump pulse because of a larger group velocity. Therefore, the leading edge of the idler is amplified as it overtakes and depletes the pump pulse; and the trailing edge of the idler pulse sees lower gain since it interacts with already-depleted sections of the pump pulse. This preferential amplification of the leading edge of the idler pulse leads to pulse compression.

It is likely that the compression characteristics of the present Raman laser system 100 are similar, with the group velocity mismatch driving the pulse compression. Using the Sellmeier equations for the KGW Raman crystal 110 [for example, as published by Pujol, et al., Appl. Phys. B 68, 187-197 (1999)], a group delay mismatch of 83 fs/mm is calculated which, over the 25 mm confocal length of the cavity waist results in the Stokes pulse overtaking the pump pulse by 2.1 ps on each pass, compared to the mismatch of 1.6 ps per pass between the pump and idler in the OPO in Rauscher, et al. This is a big enough fraction of the 10 ps pump pulse to allow compression, although at a loss of efficiency since the 3.2 ps compressed pulse does not interact with the entire 10 ps pump pulse. It is noted that the high group delay dispersion in KGW (458 fs²/mm at 559 nm) results in a similar group delay mismatch as that calculated in Rauscher, et al, despite the relatively smaller difference between the pump and Stokes wavelengths.

The main difference between the presently described Raman laser system 100 and the OPOs is that the instantaneous χ⁽²⁾ interaction is replaced with a non-instantaneous χ⁽³⁾ Raman interaction. In the stimulated Raman scattering (SRS) interaction, there is a build-up of the coherent oscillation of the vibrational mode over the dephasing time T₂, equal to 1.96 ps for the 901 cm⁻¹ mode in KGW in the Raman laser system 100 of the present example. For Stokes pulses with duration comparable to T₂ or shorter (so-called transient SRS), this build up leads to enhanced scattering of the pump at the trailing edge of a Stokes pulse. This therefore causes enhanced amplification of the tail of the pulse compared to the case in OPOs, which is likely to be the factor responsible for limiting the effectiveness of the compression observed in the present example once the Stokes pulse duration approached T₂. The effects of transient-SRS will likely also be responsible for the fact that the system 100 can tolerate far larger cavity length detunings in the negative direction: in this case, the Stokes pulse leads the pump pulse and this better aligns the maximum scattering strength at the tail of the Stokes pulse with the peak of the pump pulse.

In conclusion for the present example, a simple and efficient method for generating yellow intense short-pulse radiation by the operation of a CW synchronously pumped mode-locked Raman oscillator is demonstrated. In the presently described arrangement of the system 100, the output pulses were compressed down to 3 ps (from a 10 ps pump), generating 0.29 W at 559 nm, with green-yellow conversion efficiencies up to 18% when best compression occurred. This technique allows for easy wavelength-conversion of industry-standard mode-locked lasers using robust crystalline technology, and is ideal where a simple, reliable source of short-pulse yellow-orange radiation is needed.

### Example 2

### Ultrafast Synchronously Pumped Diamond Raman Laser System

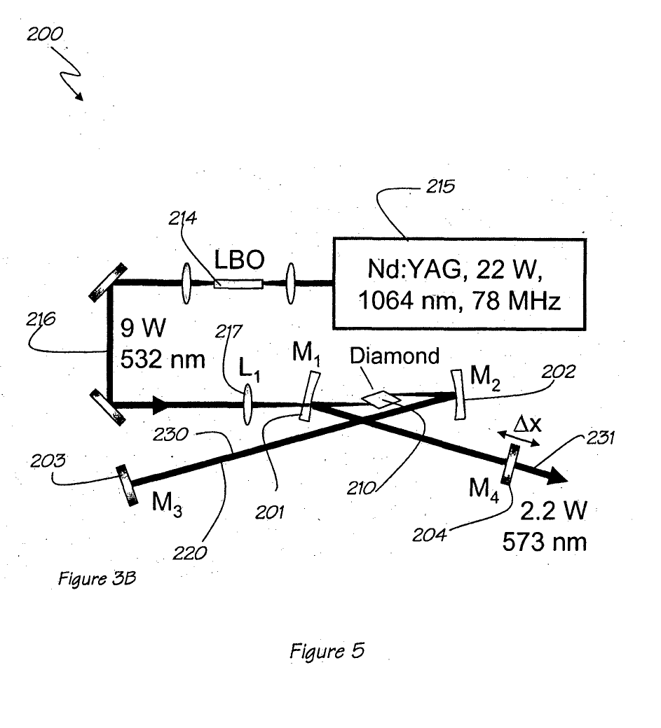

The present example describes an exemplary arrangement 200, depicted schematically in FIG. 5 of a mode locked Raman laser with diamond as the Raman medium, synchronously pumped by a mode locked laser in a further arrangement of a laser system similar to that of laser system 100 as disclosed in Example 1. Using diamond as the Raman crystal offers a greatly extended range of capability. The larger Stokes shift of diamond (1332 cm⁻¹) compared to that of KGW (768 and 901 cm⁻¹), enables an output wavelength of 573 nm from a single Stokes shift when using a 532 nm pump laser. Diamond also has a much higher gain coefficient enabling smaller crystals to be used. The longer dephasing time of diamond (6.8 ps) compared to 3.2 ps for KGW is expected to place a higher limit on the pulse duration and enable the testing of models for pulse compression limits in synchronously pumped Raman lasers as discussed below. Also, the outstanding thermal conductivity of diamond allows rapid heat removal and thus potentially very high average output powers.

In the present arrangement, the laser system 200 was observed to generate up to 2.2 W at the 573 nm first-Stokes wavelength, using a 6.7 mm long diamond crystal 210 as the Raman-active medium. A numerical model is then used to explain the dynamics of the system, showing why the pulse duration is shortened in some regimes.

The diamond laser cavity 220 is a z-fold configuration comprised of two curved reflectors, M₁ and M₂ (201 and 202 respectively), each with a radius of curvature (RoC) of +200 mm and two plane reflectors, M₃ and M₄ (203 and 204 respectively) as shown schematically in FIG. 5, where reflector M₁ 201 is a dichroic input reflector, and reflector M₄ 204 is an output reflector/coupler. The fold angle of the cavity 220 was set to about 6 degrees to compensate for the astigmatism introduced by the 6.7 mm Brewster-cut diamond Raman crystal 210. The mode locked Nd:YAG pump laser 215 is frequency doubled to 532 nm, in the present example using a second harmonic doubling process in a nonlinear medium 214 (e.g. an LBO crystal), and focused through reflector M₁ 201 into the diamond crystal 210 by a lens L1 217 to approximately match the 32 μm (1/e² radius) mode waist of the laser cavity 220 in the diamond Raman crystal 210. Up to 7.5 W of pump light 216 at 532 nm was incident on the diamond crystal 210, where the pump light 216 comprised a pulse train composed of 26 ps pulses at a repetition rate of 78 MHz. In the present arrangement, reflectors M₁ 201, M₂ 202 and M₃ 203 were adapted (using for example suitable optical coatings) to be highly reflecting at the first-Stokes wavelength of 573 nm. The output coupler reflector M₄ 204 was adapted to have a transmission of about 12% at the first Stokes wavelength of 573 nm.

As in Example 1, the position Δx of reflector M₄ 204 may be tuned to optimize the performance of the laser; where Δx=0 is defined as the cavity length measured to have the lowest laser threshold, and negative values correspond to a shortened cavity.

First optimizing the laser for maximum output power in output beam 231, which was achieved for a detuning of Δx=+50 μm for resonator cavity 220, an output power of 2.21 W at 573 nm, was measured with a input pump power of 7.5 W of 532 nm pump light 216. The laser threshold was measured to be approximately 2 W, leading to a slope efficiency of about 4.1% and an absolute efficiency of about 29% for the present arrangement.

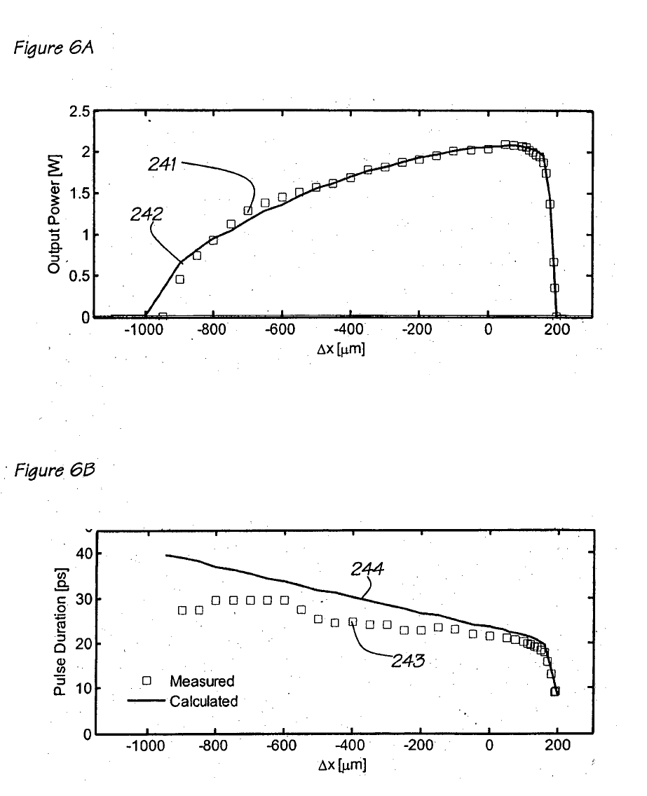

FIGS. 6A and 6B respectively show graphs of the output power and pulse duration of the output at 573 nm as a function of Δx, measured for an input pump power of 7 W. FIG. 6A shows the power output 241. The pulse duration 243 as shown in FIG. 6B was measured with a scanning second-harmonic-generation autocorrelator, with the pulse durations inferred assuming that the pulses were Gaussian in time. As can be seen from FIG. 6A, the output power behaved extremely differently for positive and negative changes in the length detuning Δx of the laser cavity 220. As can be seen in both FIGS. 6A and 6B, substantial negative detunings of up to Δx=−800 μm could be tolerated (which corresponds to a temporal mismatch of 5.3 ps per round trip) with minimal impact on the output power of the laser output beam 231, whereas a positive detuning of just +200 μm (1.3 ps) caused the laser action to cease. The highest output power was observed for a detuning of +50 μm, for which the pulse duration of the output beam 231 was measured to be about 21.3 ps (compared with the pulse duration of 26 ps of the pump light 216) as can be seen in FIG. 6B. For shorter cavity lengths, the pulse duration of the output 231 was observed to increase monotonically up to a maximum of about 30 ps for Δx=−750 μm while the output power decreased by ˜50%. For longer cavity lengths, there was a sharp reduction in pulse duration of the output 231 down to 9 ps for Δx=+200 μm while the output power decreased sharply to just above threshold so that no enhancement in output peak power was observed in the pulse-shortened regime in the present arrangement.

### Numerical Modelling

To explain the behaviour of the diamond laser in Example 2 above, a numerical model has been developed using the equations for transient Raman scattering. Of course, the numerical model is just as equally applicable to synchronously-pumped Raman laser systems with different Raman-active media as would be appreciated by the skilled addressee. The numerical model tracks the amplitudes of the Stokes and pump pulses as well as the phonon excitation, and also accounts for group velocity walk-off between the pulses through the crystal. These equations are given for example in Penzkofer at al. [Progress in Quantum Electronics 6, 55-140 (1979)] (their Equations 77-79), using different velocities for the Stokes and pump pulses, and with the assumption that the excess population of phonons is small. After using a finite difference method to transform the time- and space-dependent equations into a first-order-accurate set of time-dependent equations on a spatial grid, the equations were solved numerically using a Runge-Kutta algorithm. The algorithm was adapted to solve for a sequence of single passes through the crystal, using the output Stokes field from one pass as the input Stokes field for the following pass; the simulation is terminated when the Stokes pulse has reached its steady-state profile. The equations were solved in a frame moving at the Stokes group velocity, in order to avoid numerical dispersion for the resonated Stokes field. In the model, the cavity length detuning is simulated by retarding or advancing the Stokes pulse before it is recycled after each round trip. The experimentally-known parameters for the pump power (7 W), duration (26 ps, assuming a Gaussian temporal profile), cavity mode waist (31 μm), output coupling (12%), and diamond length (6.7 mm) were used in the model to simulate the present diamond Raman laser system 200.

The simulated output power 242 (of FIG. 6A), and output pulse duration 244 (of FIG. 6B), have been calculated from the output pulse profiles by simulating an autocorrelation measurement to allow comparison to the experimental values, with excellent agreement with the experimental data as shown in the figures, indicating that all the key physical processes of the synchronously-pumped Raman laser systems are included in the current (simplified) model. Only two parameters in the numerical model were adjusted to achieve agreement with the experimental data—the Raman gain, set to 50 cm/GW, and the passive losses of the Raman resonator at 573 nm, set to 13%. The phonon dephasing time was set to 6.8 ps, with the numerical results not sensitive to small changes. These values are consistent with expectations: the Raman gain at 532 nm is poorly known, but measurements at other wavelengths suggest it will be close to this value; the cavity passive losses comprise known reflector leakages of 6% per round trip, and unknown contributions due to scattering, absorption, and reflections from the diamond Brewster faces (a loss that can be significant owing to depolarization).

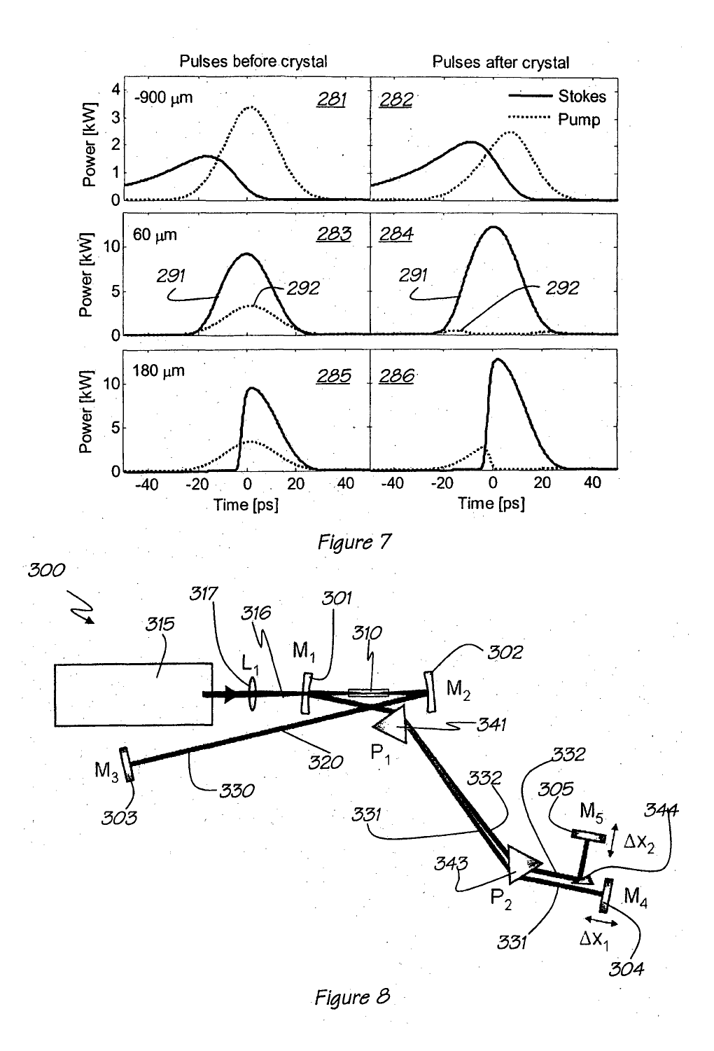

In order to elucidate the pulse shortening mechanism, the numerical model was used to analyse Stokes pulse generation as function of cavity length for the synchronously-pumped Raman laser system 200 of FIG. 5. In FIG. 7, the pulse shapes of the pump and Stokes pulses both before and after a transit through the diamond crystal are shown for a range of different Δx. The time axis is set so that a Stokes pulse moving through the crystal at its group velocity will not shift in time. This allows study of the relative timing of the pulses at the entrance and exit of the crystal, and the way the pump is depleted.

FIG. 7 shows the pulse shapes of the pump (dotted) and Stokes (solid) pulses before (left plot) and after (right plot) a single transit through the diamond Raman crystal 210, for cavity length detuning Δx of −900 μm (top frames 281 and 282), +60 μm (middle frames 283 and 284), and +180 μm (bottom frames 285 and 286). Consider first the central pair of plots in frames 283 and 284 of FIG. 7, showing the pump and Stokes pulses before (frame 283) and after (frame 284) a transit through the diamond Raman crystal 210 of laser system 200 for the cavity length corresponding to the maximum power output, Δx=+60 μm. It can be seen that the Stokes pulses 291 and pump pulses 292 are well overlapped, and that the pump pulse 292 is uniformly and effectively depleted after passing through the Raman crystal.

The top pair of plots in frames 281 and 282 in FIG. 7 shows the same parameters for a cavity length detuning of resonator cavity 220 of Δx=−900 μm (shorter cavity). For this length detuning, the round trip time for an unamplified Stokes pulse is shorter than the time between pump pulses. However, in the steady state, the Stokes round trip, time must nevertheless be equal to the pump inter-pulse period: this is achieved by the amplification of the Stokes pulse effectively retarding the pulse to later times, by preferential amplification of its trailing edge as seen in frame 282. Of course the output Stokes pulse, after application of the round trip losses and a time advance corresponding to the negative Δx, is identical to the input Stokes pulse, as required in the steady-state.

The required preferential amplification of the trailing edge of the Stokes pulse is naturally favoured in the regime of transient Raman scattering. Phonons accumulated in the crystal by interaction with the leading edges of the pump and Stokes pulses lead to highest Raman scattering cross section being experienced by the trailing edge. This natural tendency is why substantial negative detuning can be tolerated, in stark contrast to positive detunings.

The bottom pair of plots in frames 285 and 286 of FIG. 7 show the numerical results of pulse amplification for a resonator cavity length detuning of Δx=+180 μm (longer cavity). In this case, the leading edge of the pump pulse must be preferentially amplified in order to advance the Stokes pulse on each round trip. To overcome the natural tendency to amplify the tail, the Stokes pulse must be positioned in the wing of the pump pulse so that leading edge coincides with the peak of the pump pulse to maximize its gain. Even with this arrangement, the pulse can only advance a small amount, and so very little positive detuning can be tolerated. It is clear that the pulse shortening comes about from poor overlap with the pump pulse, and at the expense of efficient extraction of the pump power.

The lack of efficient pulse compression is in contrast with the previous results with the similar Raman laser system 100 of Example 1 above using a KGd(WO₄)₂ (KGW) Raman crystal in which a 50 mm long KGW crystal was able to efficiently generate 3.2 ps pulses from 10 ps pump pulses. The numerical model shows the that the important factor for efficient compression is substantial group velocity walk-off between the Stokes and pump pulses during each transit through the crystal, which allows the shorter Stokes pulse to walk through and extract the energy from the entire pump pulse. The required walk-off is more easily achieved for short pump pulses, and for a long Raman media with high group velocity dispersion (GVD). In the present example, compression is hindered since the diamond crystal is 7 times shorter, and our pump pulse is 2.6 times longer compared to that of Example 1 above.

In summary, the present Example 2 discloses a diamond Raman laser synchronously pumped at 532 nm by a mode-locked Nd:YAG laser which generated 2.2 W at the first stokes wavelength of 573 nm. The extreme asymmetry of the laser behaviour with cavity length detuning is described as a consequence of operating in the transient Raman scattering regime.

### Example 3

### Ultrafast Synchronously Pumped Multiwavelength Raman Laser System

In the present example, a further Raman laser system 300 is described, similar to that of the laser system 100 of Example 1, but configured for multi-wavelength and selectable wavelength output.

An arrangement of the multiwavelength laser system 300 is depicted schematically in FIG. 8 in which Raman crystal 310 (SRS gain medium) is a 50×5×5 mm potassium gadolinium tungstate (KGW) crystal. The Raman crystal 310 has an anti reflection coating at 532 nm, for normal incidence to minimise reflection losses off the crystal surface. The KGW Raman crystal 310 was pumped along its Nₘ axis to match the 901 cm⁻¹ Raman shift with a pump beam 316 at 532 nm to provide a first Stokes wavelength of 559 nm and a second Stokes wavelength of 589 nm. The pump beam 316 was obtained from a pump source 315 which in the present arrangement was a CW mode-locked Nd:YAG laser producing 22 W at 1064 nm with a repetition rate of 78 MHz. The 1064 nm pump radiation 316 was frequency doubled by non-critically phase-matched second harmonic generation in a 3.5 cm long lithium triborate (LBO) crystal to provide the pump beam 316 at 532 nm with approximately 7 W of optical power and a pulse duration of about 28 ps. Lens L₁ 317 was used to focus the pump beam 316 into the Raman crystal 310 and adapted to match the beam waist of the pump beam 316 in the Raman crystal 310 with the of the waist size of the resonator mode of resonator cavity 320 in the Raman crystal 310.

The design of the resonator cavity 320 of the present design as depicted in FIG. 8 was essentially a z-fold design. Concave reflectors M₁, and M₂ (301 and 302 respectively), each selected in the present arrangement to have a 20 cm radius of curvature, were separated by approximately 23 cm. This reflector separation led to a resonator cavity mode waist radius of 33 μm centred in the KGW Raman crystal 310. As in the previous examples, the angle of the z-fold cavity 320 was kept small to minimize the astigmatism of the cavity mode. For effective control over the cascading process, a pair of high dispersion F5 prisms P₁ and P₂ (341 and 343 respectively) to spatially separate the Stokes wavelengths from the resonating beam 330 resonating in the resonator cavity 320 (e.g. first stokes beam 331 and second Stokes intracavity beam 332) onto different end reflectors 304 and 305 respectively, thereby forming separate coupled resonator cavities with independent control of both cavity length and output coupling for each Stokes mode resonating in the cavity 320. The first Stokes mode 331 was configured to impinge on end reflector M₄ 304, while the second Stokes mode, when present, was directed to end reflector M₅ 305 by a small scraper reflector 344. The reflectors M₁, M₂ and M₃ (301, 302 and 303) were each selected to have high reflectivity (greater than 99% reflectivity) for the all the Stokes wavelengths in the resonating beam 330. While the laser system 300 of the present arrangement was designed for the Stokes radiation to be output through either of reflectors M₄ 304 and M₅ 305, there was also some leakage of output light at the first Stokes wavelength of 559 nm and also at the second Stokes wavelength of 589 nm through the other cavity reflectors of the resonator 320. Accordingly, the output powers reported below for the present example are the sum of all the recorded output from each of the resonator reflectors (i.e. the output coupler and the small leakages through the other imperfect resonator reflectors 301, 302, & 303 etc). As in each of the previous examples, the output coupling reflectors M₄ 304 and M₅ 305 were each adapted to be translated along the axis of the resonator cavity 330 to achieve the correct cavity length to ensure that the circulation of the intracavity fields of each of the resonating wavelength modes 331 and 332 were synchronized with the inter pulse period of the pump laser 315.

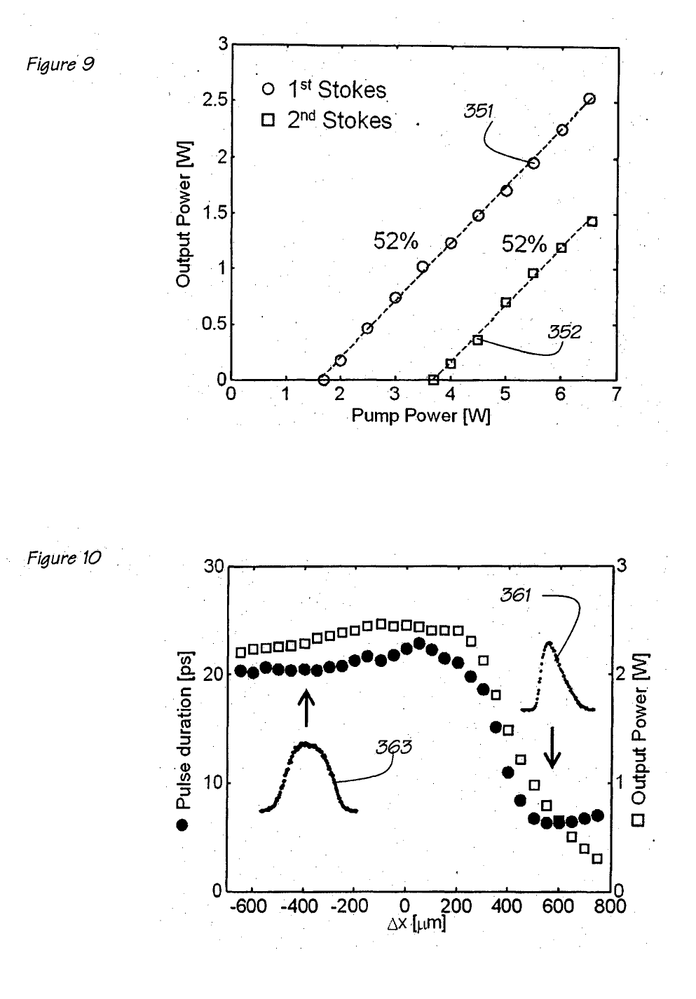

When the Raman laser system 300 was optimized to output light at the first Stokes wavelength only, reflector M₄ 304 as used in the present arrangement was an 80% transmission output coupler at 559 nm. There was no further cascading to the second Stokes wavelength in this mode. FIG. 9 shows a graph of the slope efficiency for the first Stokes (open circles 351). As can be seen from FIG. 9, the maximum CW output power at the first Stokes wavelength was about 2.5 W at 559 nm for an incident power of 6.5 W, reaching a maximum green to yellow optical conversion efficiency of 38.4%, and with a slope efficiency of 52%.

When the Raman laser system 300 was optimized to cascade to the second Stokes wavelength, both resonating first and second Stokes fields 331 and 332 were overlapped in the laser crystal but spatially separated onto reflectors M₄ 304 and M₅ 305; M₄ 304 was a high reflector at the first Stokes wavelength of 559 nm and M₅ 305 was an 80% output coupler at the second Stokes wavelength of 589 nm. Fine adjustment of each cavity length was necessary to effectively match the optimum cavity length at each Stokes wavelengths. FIG. 9 also shows the slope efficiency for the second Stokes (open squares 352): the maximum output power at the second Stokes wavelength 589 nm was 1.4 W, which was an optical conversion efficiency of 21.5%. The slope efficiency in this case for cascading to the second Stokes output wavelength was also 52%.

For the above results, the cavity lengths were optimized to achieve the highest output powers. However, for different cavity length detuning, the laser displayed substantial pulse compression, due to the complex interplay between the non-instantaneous Raman effect and the depletion of the pump field as demonstrated in the modelling results presented in Example 2 above. Accurate retrieval of the output pulse shapes has significant importance to correctly interpret the intracavity dynamics of the laser; to recover the pulse profiles we used an asynchronous cross-correlation technique. FIG. 10 shows a graph of the dependence of pulse duration and output power on the cavity length detuning, Δx in micrometers (μm), for the first Stokes output (Δx₁). As above, the cavity length detuning (Δx₁ and Δx₂) for each wavelength is defined as the difference in the cavity length from that corresponding to the minimum threshold for laser operation for each wavelength. As can be seen from FIG. 10, it was observed that the pulse compression reached its maximum when the cavity detuning was approximately Δx₁=+500 μm. The shortest pulses at this cavity detuning had a pulse shape as shown by inset 361, obtained from a cross correlation of the output pulses at the first Stokes wavelength of 559 nm, had a duration of 6.5 ps (compression factor>4), and was asymmetric with a sharp leading edge. In regions of strong compression, even though the output power was reduced the peak power was still increased: the highest peak power at 559 nm was 1.92 kW for a cavity length of Δx₁=+450 μm. For cavity length detunings Δx₁<+200 μm, the output power and pulse duration showed a long plateau that extended down to Δx₁=−2500 μm (well beyond the range of the figure). In this region, the peak power was approximately 1.4 kW, and had a pulse shape similar to that of as shown by inset 363, again obtained from a cross correlation of the output pulses at the first Stokes wavelength of 559 nm.

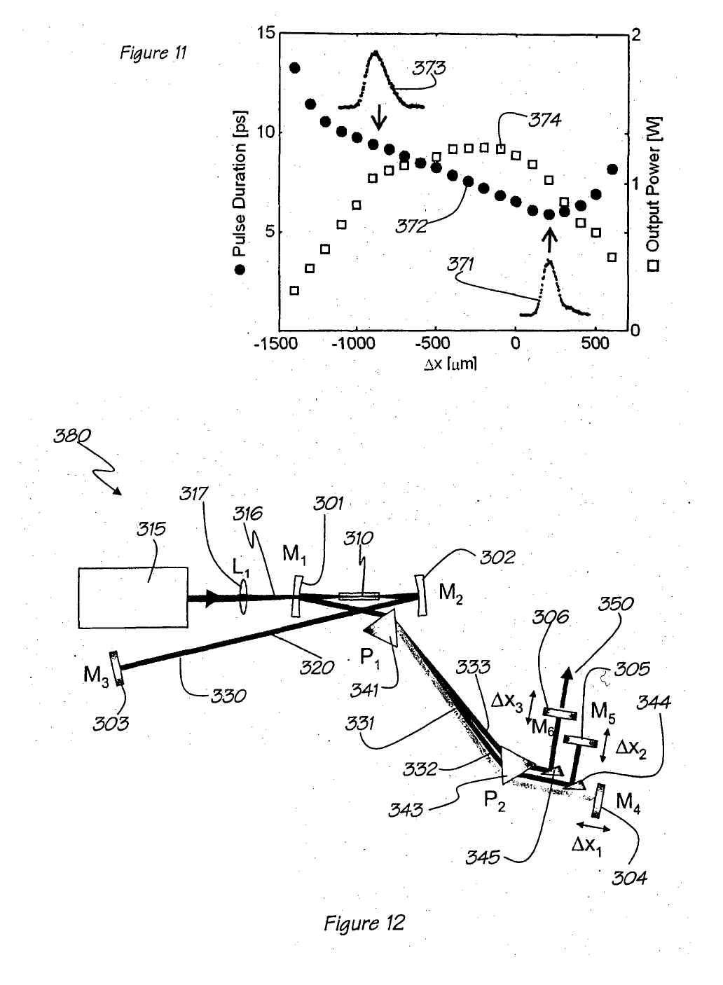

The output power and pulse duration as a function of 2^{nd} Stokes cavity length (Δx₂) is depicted in FIG. 11. In this case the cavity lengths of the 1^{st} Stokes and 2^{nd} Stokes were adjusted simultaneously by translating reflectors M₄ 304 and M₅ 305 to maximize the output power at the second Stokes wavelength of 589 nm. The results shown in FIG. 11 were measured by setting the first Stokes cavity length fixed to Δx₁=280 μm. It was observed that output pulses where shortest when the cavity detuning was approximately Δx₂=+200 μm and had a pulse shape as shown by inset 371. Those pulses had a duration of 5.5 ps (compression factor>5 from green to orange), and exhibited a small shoulder as shown in the inset cross-correlated trace 371. For negative detuning Δx, the pulse width (filled circles 372) gradually increased to about 10 ps and greater (see inset cross-correlation trace 373) as the output power (open squares 374) decreased.

In contrast with the behaviour of the compression of the 1^{st} Stokes pulses, in this case, the output power was close to its maximum when the pulse compression occurred, suggesting that the compression Mechanism for 2^{nd} Stokes was different from the 1^{st} Stokes. The maximum peak power of 2.96 kW was measured at Δx₂=+100 μm, and the maximum output power was 1.4 W. Table 3 summarizes the results for 1^{st} and 2^{nd} Stokes in different arrangements.

TABLE 3
Summary of results for multiwavelength laser system

| | | Max Peak | Min Pulse | Max Output |
|---|---|---|---|---|
| | λ | Power | duration | Power |
| Pump | 532 nm | 3.2 kW | 28 ps | 6.5 W |
| 1^{st} Stokes | 559 nm | 1.92 kW | 6.5 ps | 2.5 W |
| | | (Δx₁ = +450 μm) | (Δx₁ = +500 μm) | (Δx₁ = |
| | | | | −100 μm) |
| 2^{nd} Stokes | 589 nm | 2.95 kW | 5.5 ps | 1.4 W |
| | | (Δx₂ = +100 μm) | (Δx₂ = +200 μm) | (Δx₂ = |
| | | | | −200 μm) |

In conclusion, the present Example demonstrates a cascaded continuous-wave mode-locked Raman laser system 300 producing 2.5 W at 559 nm and 1.4 W at 589 nm. Slope efficiencies up to 52% were obtained for 1^{st} and 2^{nd} Stokes by independent optimization of the output coupling and cavity length for each Stokes order. Overall green-yellow and green-orange efficiencies of up to 38.4% and 21.5% respectively have been demonstrated, and the shortest pulses obtained correspond to 6.5 ps at 559 nm and 5.5 ps at 589 nm.

### Example 4

### Ultrafast Synchronously Pumped Multiwavelength Raman Laser System

A further arrangement 380 of the multiwavelength synchronously pumped Raman laser system disclosed herein was realised as schematically depicted in FIG. 12, where like numerals designate like components with the arrangement depicted in FIG. 8 of Example 3 above. Raman laser system 380 was realised by adding a third resonator cavity i.e. by adding a further scraping reflector 345 and further end reflector 306, aligned to resonate the third Stokes wavelength 333 in the resonator cavity 320. With this further arrangement, output light 350 at the third Stokes wavelength of 620 nm in the present arrangement was realised with an output power of more than 100 mW. In this the case, the output coupling reflector M₅ 305 for the second Stokes resonating mode 332 was replaced with a high reflector; however, substantial leakage of the second Stokes field through the other reflectors acted as a substantial loss for that field and so the laser was far from optimized for generating 620 nm. Higher output powers at 620 nm can be anticipated by further optimization of the resonator reflector coatings in further arrangements of the laser system as would be appreciated by the skilled addressee.

It is anticipated that further cascading is also possible using this technique. Constructing a similar laser system for generating an infrared cascade using 1064 nm pump radiation is also clearly available.

### Example 5

### Coupled Cavity Synchronously Pumped Raman Laser Systems

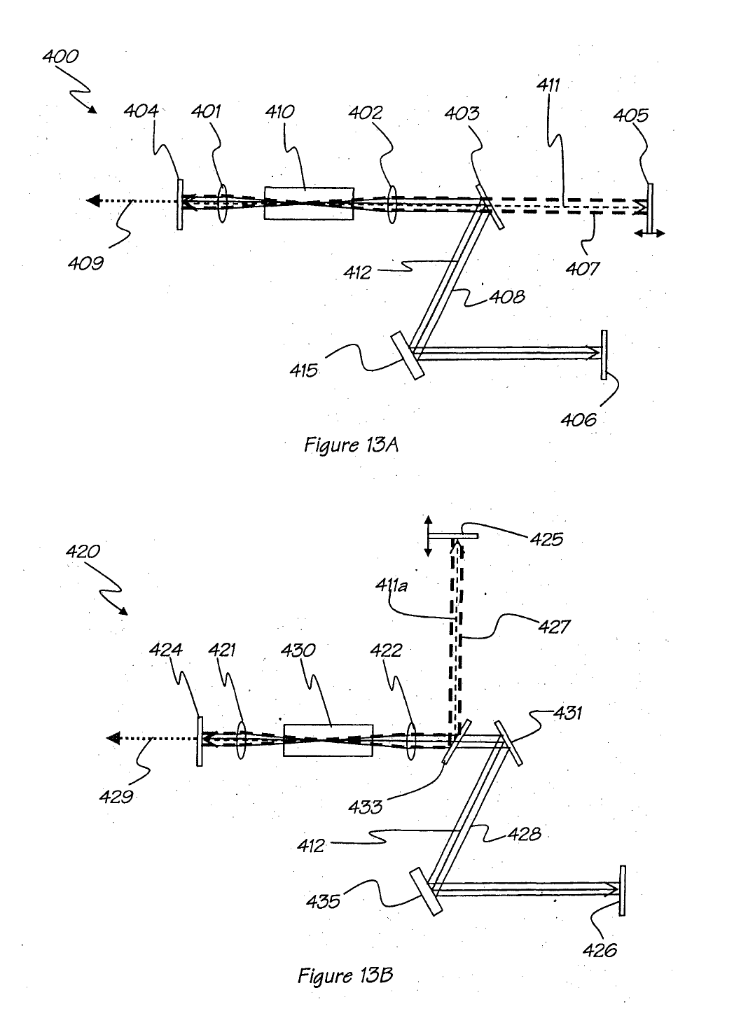

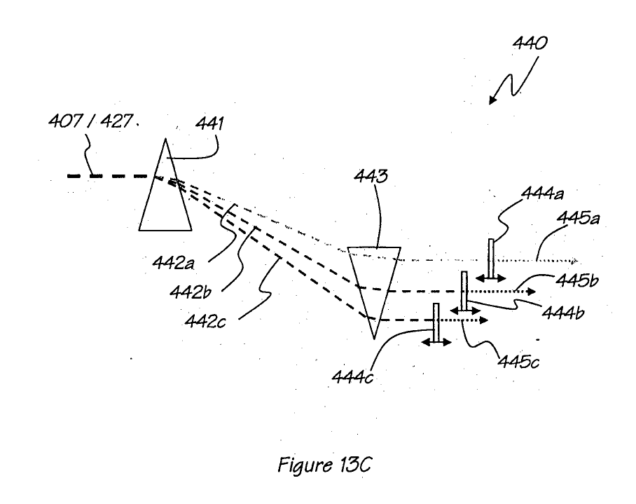

Referring to FIG. 13A, an example arrangement of a coupled-cavity synchronously pumped Raman laser system 400 is depicted schematically. In this particular arrangement, a vertical external-cavity surface-emitting laser (VECSEL) is used as the pump laser, however, it will be appreciated by the skilled addressee that similar coupled cavity arrangements may be designed with alternative pump sources, for example Nd-doped lasers operating at their fundamental wavelengths (e.g. 1.06 μm or 1.3 μm) or second or third or fourth harmonics, of the fundamental beam, or other rare-earth or transition metal ion lasers (e.g. erbium-, ytterbium-, holmium-, thulium-, cerium-, gadolinium-, praseodymium, or dysprosium-doped lasers, or combinations of one or more such rare earth dopants), Ti:Sapphire lasers, argon lasers, dye lasers, optical parametric oscillators, or semiconductor lasers.

In this arrangement, the optically-pumped semiconductor gain element 415, produces a pump beam 408 (solid lines) in a pump resonator cavity 412 formed by reflector 404 (also the output coupler in the present example), semiconductor saturable, absorber mirror (SESAM) 406 and dichroic mirror 403, and includes the solid state Raman-active medium 410 in this pump cavity 412. The Raman-active medium 410 is located in a Stokes resonator cavity 411 formed by reflector 404 and adjustable reflector 405. As can be seen, the Stokes resonator cavity 411 coincides with a portion of the pump laser cavity 412. In operation, the pump beam 408 is Raman-shifted by Raman-active medium 410 to generate Raman shifted stokes light beam 407 (dashed lines) resonating in Stokes resonator cavity 411 having a frequency corresponding to a Raman shifted frequency of the, pump beam 408. SESAM 406 causes the pump beam 408 generated by VECSEL 415 to be mode locked.

Dichroic reflector 403 is adapted (by mirror coatings and the angle of incidence) such that it is substantially fully transmissive (i.e. greater than 95% transmissive) to the wavelength of resonating Stokes beam 407 and substantially fully reflective (greater than 95% reflective) to light with the wavelength of pump beam 408. This configuration thus allows separate control of the length of the pump and Stokes cavities 412 and 411 respectively.

Reflector 404 is adapted to be highly reflective to light with the wavelength of pump beam 408 and at least partially transmitting at the Raman-converted frequency to permit a fraction of the Stokes resonating beam 407 in resonator cavity 411 to exit the cavity and form the output beam 409. Reflector 405 is adapted to be highly reflective to light with the wavelength of Raman shifted stokes light beam 407.

Optional lenses 401 and 402 in the present arrangement focus the pump and Stokes resonating light inside the Raman-active medium 410. Alternatively, lenses 401 and/or 402 may be omitted completely, or replaced with curved reflectors (for example, reflectors 403 and/or 404 and/or 405 may optionally be curved to focus the light in Raman-active medium 410).

In operation, the position of adjustable reflector 405 is moved along the optical axis of Stokes resonator cavity 411 (formed by reflectors 405 and 404) to tune the Stokes cavity 411. Tuning of the Stokes cavity 411 is performed to match the round-trip time of a pulse of pump beam 408 resonating in pump cavity 412 with that of the repetition rate of pulses of Stokes beam 407 resonating in Stokes cavity 411 such that the resonating Stokes pulses are coincident both temporally and spatially with a pump pulse in the Raman-active medium 410 on each round trip of the cavity 411, thereby to Raman amplify the resonating pulse at the Raman-converted frequency in the Raman-active medium 410.

Referring to FIG. 13B, a further example arrangement of a coupled-cavity synchronously pumped Raman laser system 420 is depicted schematically with an optically-pumped VECSEL. As in FIG. 13A, optically-pumped semiconductor gain element 435 produces pump beam 428 (solid lines) in the pump cavity 412 formed by reflectors 424 and 431 and SESAM 426. The solid state Raman-active medium (crystal) 430 is located in the Stokes resonator cavity 411a formed by reflector 424 (also the output coupler), dichroic reflector 433 and adjustable mirror 425. As above, Stokes resonator cavity 411a coincides with a portion of the pump laser cavity 412. In operation, the pump beam 428 is Raman-shifted by Raman-active medium 430 to generate Raman shifted stokes light beam 427 (dashed lines) resonating in Stokes resonator cavity 411a having a frequency corresponding to a Raman shifted frequency of the pump beam 428.

As before, dichroic mirror 426 is adapted (by mirror coatings and the angle of incidence) such that it is substantially fully transmissive (i.e. greater than 95% transmissive) to the wavelength (frequency) of resonating Stokes beam 427 and substantially fully reflective (greater than 95% reflective) to light with the wavelength (frequency) of pump beam 428. This configuration thus allows separate control of the length of the pump and Stokes cavities 412 and 411 respectively.

Reflector 424 is adapted to be highly reflective to light with the wavelength of pump beam 428 and at least partially transmitting at the Raman-converted frequency to permit a fraction of the Stokes resonating beam 427 in resonator cavity 411a to exit the cavity and form the output beam 429.

Reflector 425 is adapted to be highly reflective to light with the wavelength of Raman shifted stokes light beam 427. Lenses 421 and 422 focus the light inside crystal 430, but as before, may be omitted completely, or replaced with curved resonator reflectors (e.g. reflectors 424 and/or 433 and/or 425).

In operation, the position of adjustable reflector, 425 is moved along the optical axis of Stokes resonator cavity 411a (formed by reflectors 425, 426 and 424) to tune the Stokes cavity 411a. SESAM 426 causes the pump beam 428 generated by VECSEL 435 to be mode locked.

Referring now to FIG. 13C, it will be appreciated by the skilled addressee that the arrangements of FIGS. 13A and 13B may be modified in a similar manner to that necessary to change the apparatus of FIG. 1A to produce the apparatus of FIG. 1B, as shown schematically by the modified apparatus 440 in FIG. 1C, thereby realising multi-wavelength systems.

In FIG. 13C, beam 407/427 represents the respective Raman shifted beam of FIGS. 13A and 13B, which resonates in Stokes resonator cavity 411 and 411a respectively. The Raman shifted beam is dispersed by prism pair 441 and 443 to create a plurality of spatially separated resonating beams 442a, 442b and 442c which are respectively reflected by adjustable reflectors 444a, 444b and 444c.

In the multi-wavelength systems modified as shown in FIG. 13C, it would be advantageous to make reflectors 404 and 424 (of FIGS. 13A and 13B respectively) highly reflective for the wavelength of the Raman shifted beams resonating in the Stokes cavity (411 and 411a respectively). In this case, therefore, there is no Raman output from these reflectors (i.e. output beams 209 and 429 respectively). Instead, it is preferred to make the adjustable mirrors 444a, 444b and 444c at least partially transmissive to Raman shifted beams 442a, 442b and 442c, respectively. Therefore, the reflectors 444a, 444b and 444c are each output couplers for the respective Stokes-shifted frequencies incident thereon to provide be Raman shifted stokes output beams 445a, 445b and 445c, respectively.

### Discussion

In the present arrangements described above, the group delay difference traversing a 50 mm KGW Raman crystal (i.e. Examples 1, 3 and 4) between first Stokes and pump is 4.2 ps, with a similar delay between the second and first Stokes. This is normal dispersion with the longer wavelength travelling faster. The substantial difference between the first and second Stokes is the reason that separately adjustable cavities were required to optimize second Stokes generation. The successive compression of the generated pulses is caused in part by this group delay mismatch through the crystal, although in this case the mismatch was relatively small in comparison with the pump pulse duration, and so compression of the 1^{st} Stokes pulse was not as effective as for shorter pump pulses. The group delay differences (GDD) created by the prism pair was approximately −1 ps between the first and second Stokes, and so partially compensates for the GDD of the KGW Raman laser crystal 310 of the examples above; In principle, with a much longer prism separation, the prism pair could be used to optimize the relative cavity lengths of the first and second Stokes. However, using the prisms to separate the wavelengths onto different end reflectors allows much greater flexibility, both to tune the path lengths and to individually tailor the reflectivity of each reflector.

It is important to understand the effect of cavity length detuning on the behaviour of the pulses in the resonator cavity. Consider first the behaviour of the pump and first stokes pulses. If the cavity detuning is zero, then the round trip time at the Stokes group velocity is exactly equal to the inter-pulse period of the pump source. The group delay difference between the wavelengths means that the Stokes pulse overtakes the pump pulse by 2.2 ps during the pass through the crystal, but the cavity length is such that the relative positions of the pulses are the same after each round trip.

If the cavity is lengthened, it would at first appear that the Stokes pulse must arrive later and later compared to the pump pulse on each round trip. However, the relative positions of the pump and Stokes pulses after each round trip must actually still be the same since the laser is operating in steady-state. The lag is actually counteracted on each round trip by a reshaping of the Stokes pulse during the pass through crystal—in this case by preferential amplification of the leading edge of the Stokes pulse so that the amplified Stokes pulse is formed at a slightly advanced position. As the cavity detuning becomes more severe, a more severe pulse reshaping must take place requiring higher gain, and eventually the laser drops below threshold.

There is a strong asymmetry of the laser behaviour with the sign of the cavity length detuning. This is due to fact that the laser system is operating in the regime of transient Raman scattering. Transient effects have to be taken into account for pulse durations less than 20 times the dephasing time for the excited vibration. The pump pulse duration of the presently described arrangement is 28 ps and the dephasing time of KGW is 2.1 ps, and so accumulation of phonons during each pulse must also be accounted for. This accumulation makes the Stokes gain far higher for the trailing edge of the Stokes pulse. Negative detuning corresponds to the Stokes pulse arriving at the crystal a little early on each round trip and therefore needing to be mostly amplified on the trailing edge—this is naturally favoured in the transient scattering regime and means that much more negative detuning can be tolerated than positive detuning.

The pulse compression results from the Stokes pulse sweeping through the pump pulse during the crystal transit owing to the differing velocities, allowing a shorter Stokes pulse to sweep the energy out of a longer pump pulse. Compression is most effective for positive detuning, corresponding to the Stokes pulse arriving at the crystal a little after the pump pulse. In this case, the reshaping of the pulse to advance its position reinforces the sweep of the Stokes pulse through the pump pulse, enhancing the compression effect. Since the leading edge of the Stokes pulse is advancing through undepleted regions of the pump pulse, steepening of the leading edge is observed, as measured for positive detunings in FIG. 9. To fully understand this compression and the effect of transient Raman scattering, numerical modelling as discussed in Example 2 above in relation to the similar laser system using diamond as the Raman crystal is required.

It will be appreciated that the methods and systems described/illustrated above at least substantially provide for synchronously pumped continuous-wave mode-locked Raman laser systems, for both single- and multi-wavelength systems.

The methods and systems described herein, and/or shown in the drawings, are presented by way of example only and are not limiting as to the scope of the invention. Unless otherwise specifically stated, individual aspects and components of the Raman laser systems may be modified, or may have been substituted therefore known equivalents, or as yet unknown substitutes such as may be developed in the future or such as may be found to be acceptable substitutes in the future. The Raman laser systems disclosed herein may also be modified for a variety of applications while remaining within the scope and spirit of the claimed invention, since the range of potential applications is great, and since it is intended that the present Raman laser systems be adaptable to many such variations.

1. A Raman laser system comprising:
a resonator cavity comprising a plurality of reflectors, wherein at least one reflector is an output reflector adapted for outputting a pulsed output beam from the resonator cavity at a frequency corresponding to a Raman shifted frequency of the pump beam, wherein the output reflector is partially transmitting at the Raman-converted frequency;
a solid state Raman-active medium located in the resonator cavity to be pumped by a pulsed pump beam having, a pump repetition rate and for Raman-converting a pump pulse incident on the Raman-active medium to a resonating pulse at a Raman-converted frequency resonating in the resonator cavity;
a resonator adjustor for adjusting the optical length of the resonator to match the round-trip time of the resonating Raman-converted pulse with the pump beam repetition rate such that the resonating pulse is coincident both temporally and spatially with a pump pulse in the Raman-active medium on each round trip, to Raman amplify the resonating pulse at the Raman-converted frequency in the Raman-active medium.

2. A system as claimed in claim 1 wherein at least one reflector of the resonator cavity is an input reflector adapted for admitting the pulsed pump beam to the resonator cavity.

3. A system as claimed in claim 1 wherein the Raman shifted frequency is either a first, second or third Stokes frequency of the pump beam obtained from Raman shifting the pump beam by the characteristic Raman shift of the Raman-active medium.

4. A system as claimed in claim 1 wherein the resonator adjustor is configured to translate a selected reflector along an optical axis of the resonator cavity, thereby to adjust the optical length of the resonator cavity.

5. A system as claimed in claim 1 wherein the resonator adjustor is configured to adjust the length of the resonator cavity by a length equivalent to a round-trip time difference of +/−20 picoseconds for the Raman converted light in the resonator cavity.

6. A system as claimed in claim 1 wherein the Raman laser is a continuous-wave mode-locked Raman laser.

7. A system as claimed in claim 1 for multi-wavelength operation, wherein the resonator cavity is a primary resonator cavity and the pulsed output beam from the primary resonator’ cavity is a primary frequency-converted beam, the system further comprising:
a secondary resonator cavity comprising a plurality of secondary reflectors, wherein at least one secondary reflector is a secondary output reflector adapted for outputting a secondary pulsed frequency-converted output beam from the secondary resonator cavity at a frequency corresponding to a secondary Raman-converted frequency of the primary output beam, wherein the secondary output reflector is partially transmitting at the secondary Raman-converted frequency;
a second solid state Raman-active medium located in the secondary resonator cavity to be pumped by the primary frequency-converted beam and for Raman-converting a pulse of the primary frequency-converted beam incident on the Raman-active medium to a secondary resonating pulse at a secondary Raman-converted frequency resonating in the secondary resonator cavity;
a secondary resonator adjuster for adjusting the optical length of the secondary resonator to match the round-trip time of the resonating secondary Raman-converted pulse with the repetition rate of the primary frequency-converted beam such that the secondary resonating pulse is coincident both temporally and spatially with a pulse of the primary frequency-converted beam in the second Raman-active medium on each round trip, to Raman amplify the secondary resonating pulse at the secondary Raman-converted frequency in the second Raman-active medium.

8. A system as claimed in claim 7 wherein at least one secondary reflector is an input reflector adapted for admitting the primary frequency-converted beam to the secondary resonator cavity.

9. A system as claimed in claim 7 for multiwavelength operation, the system comprising:
a dispersive element located in the resonator cavity for spatially dispersing resonating light in the resonator cavity of different wavelengths to create a plurality of spatially separated resonating beams in two or more coupled resonator cavities; and
a plurality of adjustable reflectors corresponding to each of the spatially separated resonating beams, each adjustable reflector located such that a respective spatially separated resonating beam is incident thereon, and wherein each adjustable reflector is adapted to adjust the optical length of a respective coupled resonator cavity as seen by its respective spatially separated resonating beam thereby to match the round-trip time of the corresponding spatially separated beam with the pump beam repetition rate or the repetition rate of a beam resonating in the resonator cavity such that each of the spatially separated resonating beams are each coincident both temporally and spatially in the Raman-active medium on each round trip with a pump pulse or pulse of a resonating beam, thereby to provide a multiwavelength Raman laser system.

10. A multiwavelength Raman laser system comprising:
a resonator cavity comprising a plurality of reflectors;
a solid state Raman-active medium located in the resonator cavity, to be pumped by a pulsed pump beam having a pump repetition rate and for Raman converting light in the resonator cavity incident thereon;
a dispersive element located in the resonator cavity for spatially dispersing resonating light in the cavity of different wavelengths to create a plurality of spatially separated resonating beams in the resonator cavity;
a plurality of adjustable reflectors located such that a respective spatially separated resonating beam is incident thereon to form a plurality of coupled resonator cavities, and wherein each adjustable reflector is adapted to adjust the optical length of the respective coupled resonator cavity as seen by its respective spatially separated beam thereby to match the round-trip time of the corresponding spatially separated beam with the pump beam repetition rate or the repetition rate of a beam resonating in the resonator cavity such that each of the spatially separated resonating beams are each coincident both temporally and spatially in the Raman-active medium on each round trip with a pump pulse or pulse of a resonating beam of a different frequency,
wherein at least one of the adjustable reflectors is an output reflector adapted for outputting a pulsed output beam from the resonator cavity at a frequency corresponding to a Raman shifted frequency of the pump beam wherein the output reflector is partially transmitting at the Raman-shifted frequency.

11. A system as claimed in claim 10 wherein at least one reflector is an input reflector adapted for admitting a pulsed pump beam to the resonator cavity.

12. A system as claimed in claim 10 wherein the dispersive element spatially disperses two or more Raman shifted beams in the resonator cavity, the Raman shifted beams corresponding to the first, second, third or higher Stokes orders of the Raman-active medium.

13. A system claimed in claim 12 wherein each of the adjustable reflectors associated with each respective spatially separated beam is configured to correspond to the respective Stokes order of the spatially separated resonating beam.

14. A system as claimed in claim 10 wherein the dispersive element is selected from the group of: a grating; a prism; and a pair of prisms.

15. A system as claimed in claim 1 wherein the pump source is a mode-locked pump source.

16. A system as claimed in claim 15 wherein the pump source is a continuous wave mode-locked pump source.

17. A system as claimed in claim 1 wherein the pump source comprises a pump laser including a pump resonator cavity, wherein the pump resonator cavity is coupled with the resonator cavity.

18. A system as claimed in claim 1 wherein the system is a synchronously pumped Raman laser system.

19. A system as claimed in claim 1 wherein the pulsed output beam comprises pulses of between 0.05 and 40 picoseconds pulsewidth.

20. A system as claimed in claim 1 wherein the Raman-active medium is selected from the group of KGW (potassium gadolinium tungstate), KYW (potassium yttrium tungstate), Ba(N0₃)₂ (barium nitrate), LiI0₃ (lithium iodate), MgO:LiNb0₃ (magnesium oxide doped lithium niobate), BaW0₄ (barium tungstate), PbW0₄ (lead tungstate), CaW0₄ (calcium tungstate), other suitable tungstates or molybdates, diamond, silicon, GdYV0₄ (gadolinium vanadate), YV0₄ (yttrium vanadate), LiNb0₃ (lithium niobate), other suitable crystalline or glass materials which are Raman-active, and Raman-active optical fibres.

21. A system as claimed in claim 1 further comprising a nonlinear medium located in the resonator cavity for frequency conversion of one or more beams resonating in the resonator cavity.

22. A system as claimed in claim 21 wherein the nonlinear medium is configured for either second-harmonic generation or third-harmonic generation of a selected beam resonating in the resonator cavity.

23. A system as claimed in claim 21 wherein the nonlinear medium is configured for either sum-frequency generation or difference frequency generation of at least two beams resonating in the resonator cavity.

24. A system as claimed in 21 wherein the nonlinear medium is selected from the group of LBO, LTBO, BBO, KBO, KTP, RTA, RTP, KTA, ADP, LiI0₃ KD*P, LiNb0₃ and periodically-poled LiNb0₃.

25. A multiwavelength Raman laser system comprising:
a plurality of reflectors defining at least two coupled resonator cavities adapted to resonate a different frequency of light, wherein at least two of the plurality of reflectors are adjustable reflectors, each adjustable reflector associated with a respective coupled resonator cavity;
a solid state Raman-active medium for Raman converting light in the resonator cavity incident thereon, the Raman-active medium being located in each of the coupled resonator cavities and adapted to be pumped by a pulsed pump beam having a pump repetition rate;
a dispersive element located in the each of the coupled resonator cavitieŝ for spatially dispersing light of different frequencies to form at least two spatially separated beams, wherein each of the spatially separated beams is of a frequency adapted to be resonated in a respective coupled resonator cavity;
wherein each of the adjustable reflectors is adapted to independently adjust the optical length of a respective coupled resonator cavity to match the round-trip time of the corresponding spatially separated beam with the pump beam repetition rate or the repetition rate of a beam of different frequency resonating in a different resonator cavity such that pulses of light resonating in each of the coupled resonator cavities are each
coincident both temporally and spatially in the Raman-active medium on each round trip with a pump pulse or pulse of a resonating beam of a different frequency.

26. A system as claimed in claim 25 wherein at least one reflector is adapted to admit the pulsed pump beam.

27. A system as claimed claim 25 wherein at least one of the adjustable reflectors is adapted to output a portion of light resonating in the respective resonator cavity.

28. A system as claimed in claim 25 wherein a reflector other than one of the adjustable reflectors is adapted to output a portion of light at one or more selected output frequencies resonating in the resonator cavities.

29. A system as claimed in claim 25 comprising:
three coupled resonator cavities, each cavity adapted to resonate a different frequency of spatially separated light;
three adjustable reflectors each associated with a different resonator cavity to that of each of the other adjustable reflectors and adapted to adjust the optical length of the coupled resonator cavity with which it is associated to match the round-trip time of the corresponding spatially separated beam with the pump beam repetition rate or the repetition rate of a beam of different frequency resonating in a different resonator cavity such that each of the spatially separated resonating beams are each coincident both temporally and spatially in the Raman-active medium on each round trip with a pump pulse or pulse of a resonating beam.

30. A system as claimed in claim 25 comprising:
four or more coupled resonator cavities, each cavity adapted to resonate a different frequency of spatially separated light;
four or more adjustable reflectors each associated with a different resonator cavity to that of each of the other adjustable reflectors, and adapted to adjust the optical length of the respective coupled resonator cavity with which it is associated, to match the round-trip time of the corresponding spatially separated beam with the pump beam repetition rate or the repetition rate of a beam of different frequency resonating in a different resonator cavity such that each of the spatially separated resonating beams are each coincident both temporally and spatially in the Raman-active medium on each round trip with a pump pulse or pulse of a resonating beam.

31. A system as claimed in claim 25 wherein each of the coupled resonator cavities is adapted to resonate a frequency of light corresponding to a Stokes frequency of the Raman-active medium with respect to the frequency of the pump beam.

32.-47. (canceled)
